(19) United States
(12) Patent Application Publication
(10) Pub. No.: US 2026/0289081 A1
(43) Pub. Date: Sep. 24, 2026

(54) SYSTEM

(71) Applicant: SoftBank Group Corp., Tokyo (JP)

(72) Inventor: Yuko WATANABE, Tokyo (JP)

(73) Assignee: SoftBank Group Corp., Tokyo (JP)

(21) Appl. No.: 19/562,878

(22) Filed: Mar. 11, 2026

(30) Foreign Application Priority Data
Mar. 19, 2025 (JP) 2025-044497

(51) Int. Cl. G06F 40/166; G06F 40/103; G06F 40/226; G06N 3/045; G06N 3/0475

(52) U.S. Cl. CPC G06F 40/166; G06F 40/103; G06F 40/226; G06N 3/045; G06N 3/0475

(57) ABSTRACT

A system includes a processor that is configured to receive a request input by a user and convert the request into a bullet-point format by using a natural language processing algorithm, create, based on the request converted into the bullet-point format, a prompt for instructing a generative artificial intelligence model to generate a natural language sentence, and present the generated natural language sentence to the user via a user interface and provide an editing tool that allows the user to review the sentence and modify the sentence as needed.

### CROSS-REFERENCE TO RELATED APPLICATION

This application is based on and claims priority under 35 USC 119 from Japanese Patent Application No. 2025-044497 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for composing user inquiries or request messages require users to manually draft complete sentences in natural language. Such manual drafting is burdensome for users who are not familiar with formal writing, who have difficulty clearly structuring their intentions, or who must frequently send similar inquiries. Even when natural language processing or generative artificial intelligence models are available, users are often required to construct appropriate prompts or to understand complex interfaces, which increases cognitive load and reduces usability. Furthermore, existing systems do not sufficiently support a workflow in which a user's raw intention is captured in an unstructured form, systematically converted into a structured representation, and then converted into a high-quality natural language sentence that can be easily reviewed, edited, and transmitted as an inquiry. There is also a need for a mechanism that allows seamless transition from automatic sentence generation to user confirmation, optional editing, and final transmission of the inquiry through a communication network, including a mode where the generated sentence is transmitted automatically after user confirmation. Therefore, there is a demand for a system that reduces the burden on the user in composing inquiry sentences, while improving the accuracy and efficiency with which the user's intention is reflected in a final, transmittable natural language message.

### SUMMARY

In order to solve at least part of the above problem, according to an aspect of the present invention, there is provided a system comprising a processor, wherein the processor is configured to receive a request input by a user and convert the request into a bullet-point format by using a natural language processing algorithm. By converting the user's input into a bullet-point representation, the system extracts and structures the essential elements of the user's intention in a form that is easier to handle programmatically. The processor is further configured to create, based on the request converted into the bullet-point format, a prompt for instructing a generative artificial intelligence model to generate a natural language sentence. Through this prompt generation, the system automatically invokes the generative artificial intelligence model with context information derived from the bullet points, thereby obtaining a coherent natural language sentence that reflects the user's underlying intent. The processor is also configured to present the generated natural language sentence to the user via a user interface and to provide an editing tool that allows the user to review the sentence and modify the sentence as needed, enabling precise adjustment by the user before transmission. In addition, the processor is configured to transmit the generated natural language sentence as an inquiry of the user via a communication network, and, in one mode, to transmit the generated natural language sentence as the user's inquiry without modification, the transmission being automatically performed after confirmation by the user. By combining automatic structuring of user input, prompt generation for a generative artificial intelligence model, user-centric review and editing, and flexible transmission control, the system reduces the burden of sentence composition on the user while enabling efficient and accurate creation and sending of inquiry messages.

The term “system” refers to a combination of hardware and software components, including at least one processor and associated memory, configured to perform the functions described in the claims.

The term “processor” refers to any hardware device or combination of hardware devices capable of executing instructions, including but not limited to a central processing unit (CPU), a microprocessor, a microcontroller, a digital signal processor (DSP), a graphics processing unit (GPU), or a plurality of such devices operating together.

The term “request” refers to information representing a user's intention, question, demand, or inquiry content, which is input by the user in any textual or equivalent electronic form.

The term “user” refers to a human operator who interacts with the system, inputs the request, reviews output sentences, and optionally edits and authorizes transmission of the generated natural language sentence.

The term “natural language processing algorithm” refers to any algorithm or set of algorithms that processes human language text, including but not limited to tokenization, parsing, classification, entity extraction, summarization, segmentation, or other linguistic analysis used to convert a user's request into a structured or reformatted representation.

The term “bullet-point format” refers to a structured representation of content in which the content is divided into discrete items, each item typically expressing one element, condition, or aspect of the user's request, and arranged as a list that may be ordered or unordered.

The term “prompt” refers to a text or data structure that is provided as input to a generative artificial intelligence model to instruct the model regarding the task to be performed, including at least context and instructions for generating one or more natural language sentences corresponding to the user's request.

The term “generative artificial intelligence model” refers to a machine learning model, such as a large language model or other generative model, that is capable of generating new natural language text based on a given prompt or input context.

The term “natural language sentence” refers to a one-sentence or multi-sentence expression in a human language, such as English, that is generated by the system to represent the user's request in a coherent and readable form.

The term “user interface” refers to any interface through which the user can interact with the system, including but not limited to graphical user interfaces, web-based interfaces, or application interfaces that can display text and receive user input.

The term “editing tool” refers to a software component or set of functions provided through the user interface that enables the user to modify the generated natural language sentence, including operations such as inserting, deleting, replacing, or rearranging text.

The term “inquiry” refers to an electronic message or communication, derived from the generated natural language sentence, that is intended to be sent from the user to a destination such as a service provider, support center, or other recipient.

The term “communication network” refers to any wired or wireless network infrastructure that enables data transmission between the system and external devices or servers, including but not limited to the Internet, local area networks (LANs), wide area networks (WANs), cellular networks, or their combinations.

The term “confirmation by the user” refers to an operation performed by the user, such as clicking a button, selecting an option, or performing an equivalent input, indicating that the user has reviewed the generated natural language sentence and authorizes its transmission as an inquiry.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

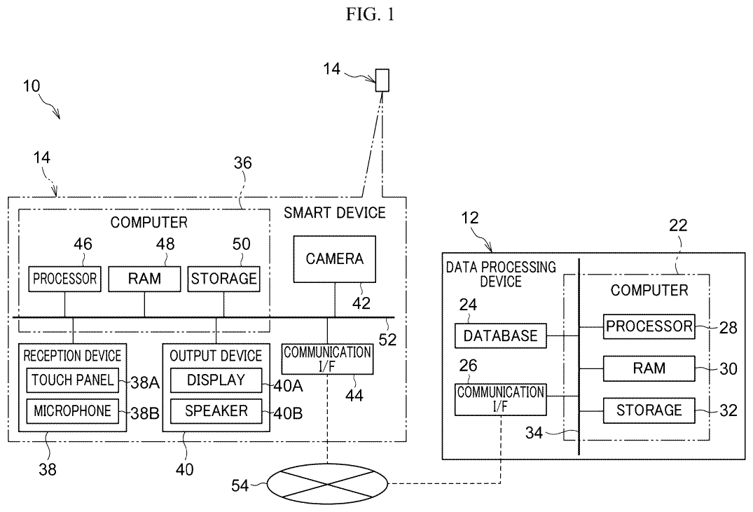

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

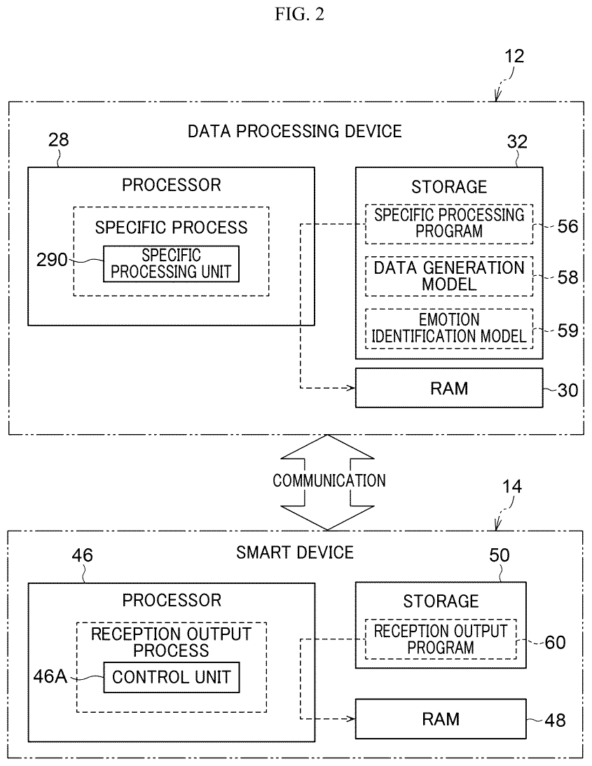

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented inquiry support systems require a user to manually compose a well-formed natural language inquiry from informal or fragmented inputs such as short phrases, bullet points, or partially structured data. Even when a natural language generation engine is available, existing systems typically pass raw user text directly to the engine without performing systematic structuring, validation, or fine-grained control of style and content. As a result, several technical problems arise in the operation of computing devices.

First, a processor in a conventional system often receives heterogeneous and noisy input data from a user terminal, and must either process it with ad hoc rules or pass it directly to a generative model. This leads to inefficient utilization of processing resources on the server and the model side, because the model is asked to infer both the structure and the intent from unstructured input. The absence of explicit structuring and validation at the server results in unpredictable outputs, increased need for retries, and additional processing to correct malformed responses, thereby degrading throughput and latency of the overall system.

Second, in typical deployments of generative AI models, a prompt sentence is constructed in an ad hoc or static manner, without explicit incorporation of itemized user requirements, style constraints, and output format constraints into a machine-handled structure. This makes it difficult for the processor to deterministically control attributes of the generated text such as language, speaker viewpoint, politeness level, and document length. Consequently, the server-side application logic must perform additional, often unreliable, post-processing to enforce business or conversational rules, which increases CPU cycles and memory usage and can lead to inconsistent behavior across different sessions.

Third, conventional systems do not tightly integrate a bidirectional loop between the generative AI model and an editable user interface at the terminal under explicit control of the processor. Generated text is typically presented as a static suggestion or is directly transmitted as a final inquiry, with limited or no structured tracking of whether the user has edited the generated text. This lack of integration prevents the processor from automatically deciding when it is safe to transmit generated text as-is, and when it should require user confirmation or additional processing, which in turn complicates workflow orchestration and error handling in large-scale networked environments.

Thus, there is a need for a computer-implemented technique that (i) systematically converts multiple user requirement items into structured data, (ii) programmatically generates a controlled prompt sentence and corresponding model input for a generative AI model, (iii) performs reliable post-processing of the generated text, and (iv) integrates user-side editing information into server-side control logic. Such a technique should improve the efficiency, predictability, and controllability of text generation workflows on the server, reduce unnecessary processing and network traffic, and enhance the overall performance and reliability of computer systems providing inquiry generation functions.

The specific processing by the specific processing unit 290 of the data processing device 12 in Example 1 is realized by the following means.

The present invention provides a server comprising a processor configured to acquire structured data including a plurality of requirement items from a user terminal and perform format validation and content validation on the structured data; convert the plurality of requirement items into a single prompt sentence suitable as input to a generative AI model by adding a fixed instruction sentence, style conditions, and output format conditions, and generate model input data including the prompt sentence; transmit the model input data to an internal or external generative AI model and request execution of natural language text generation processing; receive, as a response from the generative AI model, a generated natural language text, and perform post-processing including normalization of line breaks, character encoding, and sentence-ending expressions on the generated natural language text; generate response data including the post-processed natural language text, the plurality of requirement items, and the prompt sentence, and transmit the response data via a communication network to a terminal executing a user interface; present the natural language text, via the user interface of the terminal, as an editable input area and accept editing information that enables a user to add or modify the natural language text; and convert a natural language text finalized based on the editing information into transmission data that is transmittable as inquiry information to another information processing apparatus. This enables the server to structurally manage user requirement items, deterministically construct and supply a controlled prompt sentence to the generative AI model, reliably normalize model outputs, and automatically determine, based on explicit editing information, whether to transmit the generated natural language text as-is or in edited form, thereby improving the efficiency, predictability, and technical performance of computer-based inquiry generation and transmission processes.

The term “processor” refers to a hardware computation unit or a combination of hardware computation units, such as a central processing unit or a graphics processing unit, configured to execute instructions and perform data processing operations that implement the functions described in the present specification.

The term “user terminal” refers to an electronic device operated by a user, such as a mobile device, a portable information processing device, or a stationary information processing device, that provides a user interface and communicates with a server via a communication network.

The term “structured data” refers to data representing one or more requirement items in a predefined data format, such as a record or a data object including fields and values, that can be programmatically parsed and validated by a processor.

The term “requirement item” refers to a unit of information indicating a request, question, or intention of a user, expressed as a short phrase, a sentence, or a similar textual element, and included as an element of structured data.

The term “format validation” refers to processing by which a processor checks whether structured data or a requirement item conforms to predefined structural rules, such as data type constraints, field presence constraints, and length constraints.

The term “content validation” refers to processing by which a processor checks whether structured data or a requirement item satisfies predefined content-based rules, such as character set rules, prohibited term rules, or semantic plausibility rules.

The term “prompt sentence” refers to a text sequence generated by a processor that includes an instruction part and embedded requirement items, and that is suitable as an input to a generative AI model for inducing generation of a desired natural language text.

The term “fixed instruction sentence” refers to a predetermined text segment included in a prompt sentence that specifies a general task, behavior, or output requirement to a generative AI model, independent of specific user requirement items.

The term “style conditions” refers to one or more constraints or parameters included in a prompt sentence that define stylistic properties of an output text, such as tone, politeness level, formality, or speaker viewpoint.

The term “output format conditions” refers to one or more constraints or parameters included in a prompt sentence that define structural properties of an output text, such as language, paragraph structure, presence or absence of bullet points, and length.

The term “model input data” refers to data generated by a processor for supplying to a generative AI model, including at least a prompt sentence and optionally additional parameters such as model selection information and generation control parameters.

The term “generative AI model” refers to a machine learning model, such as a neural network language model, configured to receive model input data including a prompt sentence and generate a natural language text based on the model input data.

The term “natural language text” refers to text composed in a human language, including one or more sentences, that is generated or processed by a processor or a generative AI model for presentation to a user or for transmission as inquiry information.

The term “post-processing” refers to processing applied by a processor to a natural language text generated by a generative AI model, including operations such as normalization of line breaks, normalization of character encoding, and normalization of sentence-ending expressions.

The term “response data” refers to data generated by a processor to be transmitted to a user terminal, including at least a post-processed natural language text and optionally related information such as requirement items and a prompt sentence.

The term “communication network” refers to a wired or wireless network infrastructure, including at least one of a local area network, a wide area network, and a public packet-switched network, that enables data communication between a server and a user terminal or another information processing apparatus.

The term “user interface” refers to a software-controlled interface presented on a user terminal, including display elements and input elements, that enables a user to view data such as a natural language text and to input or modify information.

The term “editable input area” refers to a region of a user interface, such as a text entry field or a text editing component, in which a user can directly add, delete, or modify characters or text segments of a natural language text.

The term “editing information” refers to information indicating one or more user operations that add, delete, or modify portions of a natural language text presented in an editable input area, including at least a finalized version of the text or change information applied to the text.

The term “transmission data” refers to data generated by a processor for sending to another information processing apparatus, including at least a finalized natural language text and optionally additional metadata required for routing or processing.

The term “inquiry information” refers to information representing a user's inquiry, request, or question, expressed as a natural language text and formatted for transmission to another information processing apparatus, such as a service system or a support system.

The term “another information processing apparatus” refers to an electronic computing apparatus, distinct from the server and the user terminal, that receives inquiry information and performs processing such as storage, routing, or automated or human-assisted handling of the inquiry.

In one embodiment, a server cooperates with a terminal operated by a user to generate, control, and deliver natural language inquiry text based on structured requirement items. The server includes a processor, a main memory, a non-volatile storage device, and a network interface. The processor is, for example, a multi-core central processing unit and may be used in combination with a graphics processing unit to accelerate neural network inference. The terminal is, for example, a mobile information processing device or a stationary information processing device that executes a web browser or a native application.

The server stores, in the non-volatile storage device, program modules including at least a communication control module, a structured-data management module, a prompt generation module, a generative AI client module, a response post-processing module, and a transmission control module. The server loads these modules into the main memory and causes the processor to execute them. The terminal stores and executes a user interface module that is configured to present input fields and editable text regions, and to communicate with the server via a communication network using a protocol such as HTTPS.

The terminal receives, from the user, multiple requirement items as text, for example as separate lines in a multi-line input area or as elements of a list input widget. The terminal converts the user input into structured data, for example a record including an array of requirement items and additional attributes such as a target language or a politeness level. The terminal validates a basic syntax, for example that each requirement item is non-empty, and transmits the structured data to the server via the network interface.

The server receives the structured data and stores it in a data structure in the main memory, for example an array of character strings associated with metadata fields. The server performs format validation on the structured data, such as checking that the number of requirement items is within a predetermined range and that each item length does not exceed a predefined character limit. The server performs content validation by scanning the requirement items for prohibited character sequences, encoding errors, or other anomalies using pattern matching or statistical filters. When the server detects a violation of format or content constraints, the server is able to discard the offending data or request a retransmission, thereby preventing invalid data from propagating to subsequent processing stages.

The server generates a prompt sentence using the prompt generation module. The server retrieves a fixed instruction sentence from a template store in the storage device. For example, the fixed instruction sentence is:

“Please create a polite and natural inquiry sentence in English based on the following bullet points.”

The server then appends style conditions and output format conditions, which may be stored as configurable parameters. For example, the server appends:

“Use the first person (“I”) and write in a formal business tone. Output a single paragraph without bullet points.”

The server then embeds the requirement items in the prompt sentence in a list format. For example, when the structured data includes requirement items “About product availability” and “Request to change delivery date and time”, the server constructs a prompt sentence such as:

“Please create a polite and natural inquiry sentence in English based on the following bullet points.

Use the first person (“I”) and write in a formal business tone. Output a single paragraph without bullet points.
About product availability
Request to change delivery date and time”

The server generates model input data including the prompt sentence and additional control parameters. The server sets generation parameters such as a temperature value, a maximum token number, and a top-k or top-p sampling configuration. The server thereby defines, in a machine-controlled manner, the trade-off between creativity and determinism in the generation process. The server may create separate fields representing system instructions, user instructions, and conversation context to be used by a generative AI model that follows a conversational input format.

The server communicates with a generative AI model using the generative AI client module. In one embodiment, the generative AI model is implemented as a transformer-based neural network that is deployed on a remote inference server. The neural network includes an embedding layer that maps discrete tokens to vector representations, a sequence of self-attention and feed-forward layers, and an output projection layer that converts hidden state vectors into probability distributions over a token vocabulary. The server transmits the prompt sentence and control parameters to the inference server via the network interface using an application programming interface.

The generative AI model executes inference by applying the transformer layers to the tokenized prompt sentence. Each layer performs attention weight calculation using query, key, and value vectors, followed by weighted summation and nonlinear transformation. The model uses learned weight parameters that were previously obtained through supervised pre-training and, optionally, fine-tuning using large-scale text corpora and reinforcement learning based on human feedback. During the training phase, a training server minimizes a loss function, such as cross-entropy between predicted tokens and reference tokens, by updating the weights using gradient descent or a variant thereof, such as Adam optimization. The training server may apply data augmentation techniques, such as token masking or random span corruption, during pre-training to improve generalization.

The generative AI model returns a sequence of generated tokens, which the inference server converts into a natural language text. The server receives the generated text as a character string. The server uses the response post-processing module to normalize the generated text. The server converts line break codes to a unified format, converts character encoding to a standard format if necessary, enforces a consistent sentence-ending punctuation pattern, and truncates or re-requests output if the text exceeds a predetermined size. By performing this post-processing in a deterministic way, the server ensures that downstream systems receive text that conforms to internal formatting rules, reducing the need for ad hoc correction routines.

The server generates response data including the post-processed natural language text, the original requirement items, and the prompt sentence. The server also includes metadata, such as a model identifier, a generation timestamp, and token usage statistics. The server transmits the response data to the terminal using the communication control module. The terminal receives the response data and stores it locally in memory associated with the user interface module.

The terminal presents the natural language text in an editable input area, such as a text editor widget. The terminal displays the requirement items in a separate region, enabling the user to visually confirm the relationship between the input and the generated text. The user modifies the text directly in the editable input area, for example by adding details or correcting expressions. The terminal records the modified text and optionally the differences between the original and modified versions as editing information.

The terminal transmits the editing information and the final version of the natural language text to the server. The server receives this information and determines, using the transmission control module, whether the generated text was edited by comparing identifiers or checksum values between the original and final versions. When the server detects that the text was not edited, the server automatically treats the post-processed generated text as final inquiry information. When the server detects that the text was edited, the server uses the edited version as final inquiry information. In either case, the server converts the final natural language text into transmission data formatted for another information processing apparatus, such as a ticket management system or a storage unit.

The server achieves technical effects by performing these operations in specific data structures and in a particular order. Because the server converts informal requirement items into structured data and then into a controlled prompt sentence that includes explicit style and format conditions, the server reduces the entropy of the input seen by the generative AI model. This reduction enables the model to converge to desired output patterns with fewer tokens and reduces the probability of malformed or off-spec outputs. As a result, the server reduces the number of retries and corrective operations, thereby improving overall throughput and reducing latency.

The server further improves communication efficiency. By validating and normalizing data on the server side, the server avoids sending malformed or excessively long messages across the network. The server can also adapt parameters such as maximum token count based on the number of requirement items and user-specified preferences, thereby avoiding unnecessary generation of overly long text. This adaptive behavior reduces communication load between the server and the inference infrastructure, which is particularly beneficial in large-scale deployments.

The server improves accuracy and consistency of generated text. By embedding requirement items as discrete list entries and adding explicit conditions regarding language, speaker viewpoint, politeness level, and document length into the prompt sentence, the server imposes a deterministic framework for the generative AI model. This framework allows the server to control, in a reproducible way, the higher-level attributes of the generated text, such as whether the text uses first-person expressions or satisfies a required politeness level. The server thus reduces variation and inconsistency that would otherwise require human correction.

The server also improves internal data management. The structured-data management module organizes user inputs, prompt sentences, generated outputs, and editing information into defined data structures, such as linked records or indexed tables. This organization facilitates auditing, debugging, and further training or adaptation of the generative AI model. In some embodiments, the server stores pairs of requirement items and final edited texts and uses them as additional training data to fine-tune a domain-specific model using supervised learning. The server minimizes a loss function defined over such pairs and updates model weights accordingly.

In another embodiment, the server deploys an internal generative AI model instead of relying on an external inference service. The internal model runs on a local graphics processing unit using a neural network framework. The server loads model parameters from storage into GPU memory, tokenizes the prompt sentence using a tokenizer, and runs the transformer layers through a series of kernel invocations on the GPU. The server controls batch size and sequence length to optimize GPU utilization. This arrangement reduces network latency and provides deterministic performance characteristics for high-throughput scenarios.

In a further embodiment, the server employs additional rule-based modules that operate before or after generative inference. The server may, for example, maintain a list of domain-specific expressions and enforce their inclusion or exclusion via post-processing rules. The server may also adjust model generation parameters dynamically based on the number of requirement items or on the historical performance of previous generations for similar items. These non-conventional control strategies enable the server to steer generative behavior using observed system-level metrics, such as error rates or response times, rather than relying solely on human operators.

The system thus provides more than an automation of human writing. The server reorganizes unstructured user intent into a structured protocol for interaction between the terminal, the server, and the generative AI model. This protocol, including the construction of the prompt sentence, the selection of inference parameters, and the normalization and conditional transmission of results, leads to measurable improvements in processing speed, accuracy, and resource utilization on computing hardware. The integration of structured data validation, controlled prompt sentence generation, neural network inference, deterministic post-processing, and user-informed transmission decisions results in a tangible improvement in the functioning of the server and the associated communication network.

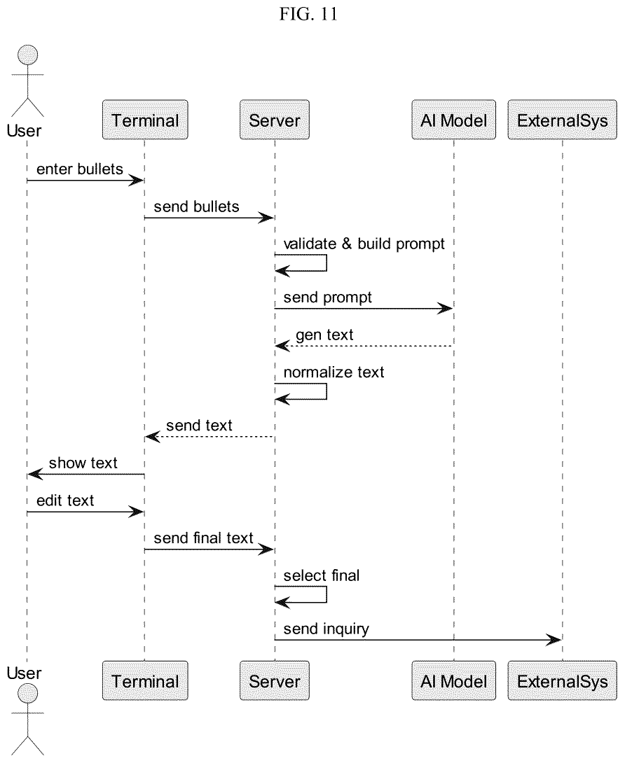

The following describes the processing flow using FIG. 11.

### Step 1

User operates the terminal and inputs multiple requirement items.

User provides, as input, informal textual fragments such as “About product availability” and “Request to change delivery date and time” via a multi-line text field or multiple text boxes. Based on this input, user separates each intention into an individual item, thereby creating a logical list of requirement items that can be further processed by the terminal.

### Step 2

Terminal structures the input data and performs basic validation.

Terminal receives, as input, the raw text strings entered by user. Terminal splits the text into an array of requirement items (for example, by line breaks or by separate fields), removes leading and trailing whitespace, and assembles a structured data object that includes the array of items and optional attributes such as a target language flag. Terminal checks that each item is non-empty and within a predefined character limit. As output, terminal produces structured data representing the plurality of requirement items in a machine-readable format.

### Step 3

Terminal transmits the structured requirement data to the server.

Terminal takes, as input, the structured data produced in Step 2. Terminal serializes this data into a network-transmissible format and encapsulates it in a network request message addressed to the server. Terminal sends this request via a communication network using a secure protocol. As output, terminal produces a transmitted request packet that contains all requirement items and associated attributes.

### Step 4

Server receives the request and performs format validation.

Server accepts, as input, the request packet from the terminal through a network interface. Server deserializes the packet into an internal data structure, such as a record containing an array of strings. Server verifies structural properties, including the number of requirement items, the length of each item, and the presence of required fields. Server discards or flags malformed entries and generates an internally validated representation of the requirement items. As output, server provides a cleaned and format-validated data structure ready for further processing.

### Step 5

Server performs content validation on the requirement items.

Server takes, as input, the format-validated requirement items from Step 4. Server scans the text of each item using predetermined rules, such as character set filters, prohibited word lists, and pattern-based anomaly detectors. Server may remove or mask prohibited substrings, normalize characters, or, if necessary, reject the entire set. As output, server generates a content-validated set of requirement items, in which each entry conforms to predefined content rules.

### Step 6

Server constructs the base prompt sentence template.

Server receives, as input, the content-validated requirement items and configuration parameters (for example, desired language and tone). Server retrieves from storage a fixed instruction sentence and style and format condition texts. For example, server retrieves the following instruction and conditions:

“Please create a polite and natural inquiry sentence in English based on the following bullet points.

Use the first person (“I”) and write in a formal business tone. Output a single paragraph without bullet points.”

Server concatenates these sentences to form a base prompt template string that does not yet include the specific requirement items. As output, server produces a base prompt template configured for the generative AI model.

### Step 7

Server embeds requirement items into the prompt sentence as a list.

Server takes, as input, the base prompt template from Step 6 and the array of content-validated requirement items from Step 5. Server iterates through the array and formats each item with a prefix symbol, such as “−”, and appends each formatted item to the end of the base prompt template, inserting appropriate line breaks. For example, server produces a prompt such as:

“Please create a polite and natural inquiry sentence in English based on the following bullet points.

Use the first person (“I”) and write in a formal business tone. Output a single paragraph without bullet points.
About product availability
Request to change delivery date and time”

As output, server generates a complete prompt sentence string that explicitly incorporates all requirement items.

### Step 8

Server generates model input data for the generative AI model.

Server receives, as input, the complete prompt sentence from Step 7 and configuration parameters such as model identifier, temperature, and maximum token limit. Server constructs a model input structure by combining the prompt sentence with these parameters, mapping them to fields required by the generative AI model's interface. Server may also include contextual fields, such as a system role description. As output, server produces model input data that is suitable for direct submission to the generative AI model.

### Step 9

Server sends the model input data to the generative AI model and initiates inference.

Server takes, as input, the model input data generated in Step 8. Server encapsulates this data in a request message that conforms to the generative AI model's application programming interface, and transmits this message to an internal inference engine or an external inference service over a communication channel. This transmission causes the receiving system to execute transformer-based processing on the prompt sentence. As output, server produces an inference request and initiates a computation sequence that will return generated text.

### Step 10

Server receives the generated natural language text from the generative AI model.

Server obtains, as input, a response message from the generative AI model that contains token sequences representing generated text. Server extracts the text field from the message, decodes token identifiers into characters, and reconstructs one or more sentences that form the natural language output. As output, server produces a raw generated natural language text string corresponding to the input prompt sentence.

### Step 11

Server performs post-processing and normalization of the generated text.

Server takes, as input, the raw generated natural language text from Step 10. Server applies normalization operations, including converting line breaks to a uniform format, ensuring consistent character encoding, trimming leading and trailing spaces, and adjusting sentence-ending punctuation to match a predefined style. Server may also truncate the text if it exceeds a maximum length, or reformat it to a single paragraph. As output, server generates a post-processed natural language text string that adheres to internal formatting rules.

### Step 12

Server packages response data for the terminal.

Server receives, as input, the post-processed text from Step 11, the original requirement items from Step 5, and the prompt sentence from Step 7. Server creates a response object that includes all three elements and may add metadata such as model identifier and generation time. Server serializes this object for network transmission. As output, server produces response data that allows the terminal to display both the generated text and its underlying context.

### Step 13

Server transmits the response data to the terminal.

Server takes, as input, the response data from Step 12. Server encapsulates this data in a network response message and sends it through the communication network to the terminal that originated the request. Server sets appropriate headers and status information. As output, server delivers a network message that carries the generated natural language text, the requirement items, and the prompt sentence to the terminal.

### Step 14

Terminal receives and parses the response data.

Terminal obtains, as input, the network response message from the server. Terminal deserializes the payload into internal structures, extracting the post-processed natural language text, the requirement items, and the prompt sentence. Terminal maps these elements to data fields used by the user interface module. As output, terminal provides structured response data suitable for display and editing.

### Step 15

Terminal displays the generated text and requirement items in the user interface.

Terminal receives, as input, the structured response data produced in Step 14. Terminal renders the requirement items in a list or table region and inserts the post-processed natural language text into an editable input area component. Terminal configures the component to allow cursor movement, text insertion, and deletion. As output, terminal presents a visual display through which user can view the original items and the generated text, and interact with the text using input devices.

### Step 16

User reviews and optionally edits the generated natural language text.

User takes, as input, the generated natural language text and the displayed requirement items presented on the terminal. User evaluates whether the text accurately and completely reflects the intended inquiry and performs edits, such as adding details or changing wording, using keyboard or touch input. As output, user produces a revised version of the natural language text, which the terminal records as the final text or as both an original and modified pair.

### Step 17

Terminal collects editing information and final text from the user interface.

Terminal receives, as input, the state of the editable input area after user completes editing. Terminal compares the final text with the original post-processed text to determine whether any modifications were applied. Terminal then generates editing information, which may include the final text itself and a flag indicating whether the user edited the text. As output, terminal produces a data object containing the final natural language text and editing status.

### Step 18

Terminal transmits the final text and editing information to the server.

Terminal takes, as input, the data object from Step 17. Terminal serializes this information and sends it to the server via the communication network, including the final natural language text and any associated metadata. As output, terminal generates and transmits a network message signaling completion of user review.

### Step 19

Server determines which version of the text to use as inquiry information.

Server receives, as input, the final text and editing information from Step 18, together with the original post-processed text stored from Step 11. Server examines the editing flag or compares identifiers to determine whether user modified the text. If no modification occurred, server selects the post-processed generated text as final; if a modification occurred, server selects the edited text. As output, server produces a single finalized natural language text to be used as inquiry information.

### Step 20

Server converts the finalized text into transmission data for another information processing apparatus.

Server takes, as input, the finalized natural language text from Step 19 and any associated routing or classification metadata. Server packages this text into a format accepted by another information processing apparatus, such as a standardized request message or record schema. Server may add identification fields, timestamps, and categorization tags. As output, server generates transmission data representing the inquiry information, which can be stored, routed, or further processed by external systems.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented inquiry systems require users to manually compose complete natural-language messages based on their intentions, often in a constrained user interface on a client device. This typically forces users to translate fragmented intentions or short bullet points into coherent sentences by themselves. As a result, users may provide ambiguous, incomplete, or excessively long inquiry texts, which degrades the precision of downstream automated processing such as routing, classification, and information retrieval.

From a computing-technology standpoint, existing systems treat user input and natural-language generation as separate, loosely coupled stages: the client device merely collects free-form text, and a server-side system handles that text without structured knowledge of the original intent granularity (for example, the individual bullet-point items). This architecture fails to exploit structured intent information for prompt construction, quality control, and automatic classification. In addition, many known natural-language generation pipelines output text that is either directly delivered to a recipient or merely previewed by the user, without a programmatic loop that (i) enforces quality constraints on the generated text, (ii) supports structured editing on the client side, and (iii) feeds the final text into machine-driven inquiry routing based on explicit categories.

Furthermore, typical server systems do not manage the interaction with a generative AI model in a way that consistently transforms structured bullet-point data into a prompt sentence, validates and normalizes the generated text, and then converts the final result into formalized inquiry data enriched with classification output. This leads to inefficiencies in server resource usage and in the accuracy of automated support workflows. There is therefore a need for an improved computer-implemented mechanism that: (1) accepts user input as multiple structured request items, (2) programmatically constructs a prompt sentence for a generative AI model, (3) performs quality-oriented post-processing of generated natural-language text, (4) supports user editing in a controlled feedback loop, and (5) automatically classifies and routes the final inquiry within server-side processing systems, thereby improving the overall functioning of the computing system itself.

The specific processing by the specific processing unit 290 of the data processing device 12 in Application Example 1 is realized by the following means.

The present invention provides a server comprising a processor configured to receive, from a terminal operated by a user, a plurality of request information items in a bullet-point format as structured data, to construct, based on the structured data, a prompt sentence including a generation instruction for a generative AI model and to transmit the prompt sentence to the generative AI model, to obtain, from the generative AI model, response data including a natural-language sentence generated in response to the prompt sentence and to perform string-formatting processing and quality-checking processing on the natural-language sentence, to transmit the natural-language sentence that has passed the quality-checking processing to the terminal for display in an editable region and to acquire a corrected natural-language sentence through an editing operation performed on the terminal, to register the corrected natural-language sentence as inquiry information in a storage unit and to output the corrected natural-language sentence as inquiry data to an inquiry-processing system or an information-retrieval system, and optionally to automatically transmit the generated natural-language sentence without user editing as inquiry information and to determine, using a classification model or a generative AI model, an inquiry category and a processing destination or processing priority within the inquiry-processing system based on the inquiry data. This enables the computing system to more efficiently convert structured user intent into high-quality, machine-processable inquiry data, to improve the reliability and consistency of generative AI-based text creation through server-side quality control, and to enhance the technical performance of automated routing and handling of inquiries in server-side processing environments.

The term “processor” refers to a hardware computation unit, or a combination of hardware computation units, configured to execute instructions of a program, and may include a central processing unit, a graphics processing unit, a digital signal processor, or any combination thereof.

The term “terminal” refers to an information processing apparatus operated by a user, including but not limited to a smartphone, a tablet device, a notebook computer, a desktop computer, or any other client device capable of communicating with a server via a communication network.

The term “user” refers to a human operator or an entity that operates the terminal to input request information, review generated natural-language sentences, and optionally perform editing operations.

The term “request information” refers to information items that express a user's needs, inquiries, questions, or unclear points with respect to a service, product, or system, and that are provided by the user as textual input.

The term “bullet-point format” refers to a representation of multiple request information items as a list of discrete elements, each element corresponding to a separate request or intention, and not yet combined into a single coherent natural-language sentence.

The term “structured data” refers to data that encodes the plurality of request information items in an organized form, such as an array, record, or object with predefined fields, thereby enabling programmatic access, manipulation, and transmission by the processor.

The term “prompt sentence” refers to a machine-readable natural-language or semi-natural-language text string that includes a generation instruction and content derived from the structured data, and that is configured to be supplied as input to a generative AI model to cause the model to generate a natural-language sentence.

The term “generation instruction” refers to a part of the prompt sentence that specifies to the generative AI model how to process the request information, including at least one of a desired output style, language, tone, format, length, or level of politeness.

The term “generative AI model” refers to a machine-implemented model, such as a neural network-based language model, that is configured to generate natural-language text as output in response to a prompt sentence, by performing probabilistic computation over internal parameters.

The term “generative AI model interface” refers to a software component or communication interface through which the processor transmits the prompt sentence to, and receives generated text from, the generative AI model, and may include an application programming interface, a network protocol layer, or a software library.

The term “response data” refers to data returned from the generative AI model, including at least a generated natural-language sentence produced in response to the prompt sentence, and optionally including metadata such as model identifiers, scores, or generation parameters.

The term “natural-language sentence” refers to a text string composed in a human language, such as a complete inquiry sentence, that is suitable for direct reading and understanding by a human recipient.

The term “string-formatting processing” refers to processing performed by the processor on the generated natural-language sentence, including at least one of trimming whitespace, normalizing character encoding, adjusting line breaks, adding prefixes or suffixes, or unifying punctuation, in order to obtain a standardized text output.

The term “quality-checking processing” refers to a programmatic evaluation performed by the processor on the generated natural-language sentence, including at least one of length checking, non-emptiness checking, prohibited-term checking, language or character-set checking, or format conformity checking, to determine whether the sentence satisfies predetermined quality criteria.

The term “editable display region” refers to a user interface component on the terminal that displays the natural-language sentence and accepts editing operations by the user, such as insertion, deletion, or modification of characters, words, or phrases.

The term “editing operation” refers to an input action performed by the user on the terminal to modify the natural-language sentence, including typing, selecting, deleting, copying, pasting, or rearranging text.

The term “corrected natural-language sentence” refers to the version of the natural-language sentence obtained after the user performs at least one editing operation in the editable display region, or, in the absence of editing, to the original generated natural-language sentence treated as final.

The term “inquiry information” refers to data stored on the server side that represents a finalized inquiry intended to be processed by an inquiry-processing system, including at least the corrected natural-language sentence and optionally associated metadata such as timestamps or user identifiers.

The term “storage unit” refers to a memory component, or a combination of memory components, such as a semiconductor memory, a magnetic storage device, or a database system, that is configured to store inquiry information and related data.

The term “inquiry data” refers to data derived from the inquiry information and formatted in a manner suitable for transmission to and processing by an inquiry-processing system or an information-retrieval system.

The term “inquiry-processing system” refers to a server-side system or application that receives inquiry data and performs processing such as ticket creation, response generation, assignment to support personnel, or workflow management.

The term “information-retrieval system” refers to a system configured to search and retrieve relevant information from one or more data sources, such as document repositories or knowledge bases, based on the content of inquiry data.

The term “automatic transmission control” refers to a processing function performed by the processor that, under certain conditions including the absence of user editing, automatically transmits the generated or quality-checked natural-language sentence as inquiry data to the inquiry-processing system or the information-retrieval system without further user confirmation.

The term “classification model” refers to a machine-implemented model that receives text, including the corrected natural-language sentence, as input and outputs at least one category label or score representing a predicted inquiry category.

The term “inquiry category” refers to a classification label assigned to an inquiry, such as a type, topic, or subject, that is used to control routing, prioritization, or selection of processing procedures within the inquiry-processing system.

The term “processing destination” refers to a logical or physical endpoint within the inquiry-processing system, such as a particular queue, module, department, or service, to which inquiry data is routed for further handling.

The term “processing priority” refers to a level or order in which inquiry data is scheduled for processing within the inquiry-processing system, based on at least one factor such as the inquiry category, user attributes, or system configuration.

In one embodiment, a server cooperates with one or more terminals operated by users to generate, refine, and route inquiry text using a generative AI model. The server is implemented on general-purpose computer hardware, such as an x86-based or ARM-based processor, main memory, non-volatile storage, and a network interface. The server executes an operating system such as a general-purpose server operating system, and runs server-side application software implemented, for example, in a runtime environment such as a Java virtual machine or a scripting language interpreter. The terminal is implemented by a client device, such as a smartphone, tablet computer, or personal computer, executing a client application or a web browser.

The terminal provides a graphical user interface that includes one or more input fields for bullet-point items and an editable text area for natural-language sentences. The terminal uses a browser engine or a native UI framework to render these components and to capture input events. The terminal stores each bullet-point item as an element of a list or array data structure in client-side memory. The terminal validates that each bullet-point string is not empty and does not exceed a configured character length, and rejects invalid items before transmission to the server.

The server receives, via a communication network, structured data representing the plurality of bullet-point items from the terminal. The server parses a structured representation, such as a list of text strings accompanied by metadata (for example, language code, user identifier, and timestamp), and stores this representation temporarily in volatile memory. The server may also write the original structured data to a database system for later analysis or auditing. The server normalizes the text content of each bullet-point item using string manipulation routines, such as Unicode normalization, whitespace trimming, and punctuation unification, so that subsequent processing by the generative AI model is not adversely affected by inconsistent input formatting.

The server constructs a prompt sentence as a single text string by combining a fixed instruction segment with the normalized bullet-point items. The server uses a deterministic joining rule, such as inserting delimiter characters or enumerating the items with conjunctions, to preserve the structure of the bullet-point list within the prompt sentence. For example, the server may generate the following prompt sentence: “Please generate an inquiry sentence based on the following bullet points: checking product availability, requesting information on return procedures.”

In another example, the server may generate a prompt sentence that additionally specifies output conditions:

“Please generate a single polite Japanese customer inquiry sentence based on the following bullet points, and do not include any bullet points in the output: checking product availability, requesting information on return procedures.”

The server transmits the prompt sentence as input to a generative AI model via a programmatic interface. In one embodiment, the generative AI model is a transformer-based neural network language model that has been trained on large-scale text corpora. The server invokes the model through a network API or a local library interface, providing, in addition to the prompt sentence, model parameters such as a temperature parameter controlling sampling randomness, a maximum number of output tokens, and a top-p or top-k parameter controlling nucleus sampling or token truncation. The server sends the prompt sentence and the parameters in a structured request and receives, in response, a structured output including at least one generated natural-language sentence string.

The generative AI model uses an internal tokenization algorithm to convert the prompt sentence into a sequence of token identifiers. The generative AI model processes the token sequence through multiple transformer layers, each including linear projections for query, key, and value vectors, multi-head attention mechanisms, and feedforward networks with non-linear activation functions. The generative AI model computes, for each position, a probability distribution over a vocabulary of possible output tokens using a softmax function applied to a linear projection of the final hidden state. The generative AI model selects a next token according to the sampling strategy dictated by the temperature and top-p or top-k parameters, appends the selected token to the sequence, and iterates this process until an end-of-sequence token is produced or the maximum number of tokens is reached. The server does not perform these internal neural network computations directly, but the server configures the parameters and thereby controls the behavior of the generative AI model to meet system-level performance requirements.

The server performs post-processing on the generated natural-language sentence. The server removes leading and trailing whitespace, normalizes punctuation and line breaks, and may add or remove specific phrases according to a rule set stored in configuration data. The server performs a quality-checking operation that includes verifying that the generated natural-language sentence is not empty, that the length in characters or tokens does not exceed a configured upper limit, and that no prohibited substrings or character classes are present. The server may further verify that the language of the output matches an expected language code by using a lightweight language-identification model. If any quality criterion fails, the server may either request a regeneration from the generative AI model with adjusted parameters or generate an error status for return to the terminal.

The server transmits the natural-language sentence that has passed quality checking to the terminal. The terminal displays the sentence in an editable text area, using its UI framework to allow cursor movement, text selection, insertion, and deletion. The user views the generated sentence and may perform editing operations. The terminal captures the user's keystrokes or touch gestures as edit events and updates the text in local memory accordingly. The terminal may present additional UI controls, such as a button to confirm the final text or a button to request regeneration of the sentence, and these controls generate corresponding commands to the server.

The user may choose to accept the generated sentence without modification or may refine the sentence. For example, the user may edit the sentence:

“I would like to check the availability of the product. In addition, please let me know the return procedure.”

into a more formal variant:

“Could you please inform me of the current availability of the product? I would also appreciate it if you could provide details regarding the return procedure.”

The terminal sends the final version of the sentence, along with identifiers for the original bullet-point data and the user, to the server. The server stores the final sentence as inquiry information in a persistent storage unit, such as a relational database or a key-value store. The server associates the final sentence with metadata including timestamps, user identifiers, original bullet-point content, and quality-checking results. This structured storage enables subsequent retrieval, analysis, and auditing of inquiries.

The server may optionally perform automatic classification of the inquiry using a classification model or by reusing the generative AI model with a classification prompt. In one embodiment, the server converts the final natural-language sentence into a vector representation using a text embedding model and inputs this vector to a classifier, such as a neural network or a gradient-boosted decision tree, that outputs a probability distribution over a set of predefined inquiry categories including, for example, inventory-related inquiries, return-related inquiries, or account-related inquiries. The server selects the category with the highest probability that exceeds a configured threshold and stores this category as part of the inquiry information. The server determines a processing destination or processing priority in an inquiry-processing system based on this category; for example, certain categories may be routed to specific processing queues or assigned higher priority for response. By performing this automated classification on structured input and high-quality generated text, the server reduces manual routing overhead and improves the determinism and traceability of server-side workflows.

In another embodiment, the server uses the same generative AI model to determine the category by constructing a classification-oriented prompt sentence that instructs the model to output only a category label. The server then parses the output text and maps it to an internal category identifier. In either case, the server implements explicit post-processing checks, such as verifying that the returned category belongs to an allowed set, thereby preventing ambiguous or unexpected labels from propagating into downstream systems.

The server achieves technical improvements in computing performance and data management by using the structured bullet-point input and deterministic prompt-construction logic. Because the server receives request information as multiple discrete bullet-point items, the server can form a compact prompt sentence that focuses on the essential content of the user's intent. This reduces the length of the prompt compared with free-form user narratives and thereby reduces the number of tokens that the generative AI model must process. Consequently, the server decreases the computational load on the model infrastructure and shortens inference time, which yields faster end-to-end response times. The structured representation also enables the server to cache partially processed bullet-point data and to reuse bullet-point items across multiple prompt sentences, further improving computational efficiency.

The server further improves accuracy and consistency of generated text by enforcing quality-checking criteria and systematic string-formatting rules. These operations reduce noise in the generated sentences and increase their conformity to a standard format expected by downstream systems. As a result, the classification model sees more homogeneous input distributions, which improves classification accuracy and reduces misrouting of inquiries. Because the server automatically records both the structured bullet-point data and the final corrected sentence, the system maintains a robust audit trail that can be analyzed to refine the generative AI model prompts, classification thresholds, and quality-checking rules over time. This continuous feedback loop results in improved computing behavior at the system level, not merely a substitution of human writing labor. The server uses non-conventional processing sequences that differ from human manual composition. For example, the server first normalizes bullet-point input, then merges it into a machine-oriented prompt sentence with a specific template, then subjects the model output to algorithmic quality checks, and only then provides it for user editing. This order increases the likelihood that the user interacts with already well-formed text and reduces the number of edits required. Additionally, the server uses deterministic rules to detect cases where the user performs no edits within a specified time window or explicitly accepts the generated sentence. In such cases, the server invokes an automatic transmission control function to send the quality-checked sentence as inquiry data to the inquiry-processing system without requiring a separate user confirmation step. This non-standard control flow is tailored to the characteristics of the generative AI model and results in reduced user interaction latency and fewer network round trips.

The generative AI model itself can be trained using supervised learning on pairs of bullet-point lists and corresponding high-quality inquiry sentences. During training, the model receives as input a text serialization of bullet-point lists and a corresponding desired sentence as target output. The model adjusts its internal weight parameters by minimizing a loss function such as cross-entropy between the predicted token distribution and the ground-truth tokens. The model uses stochastic gradient descent or a variant such as Adam to update its weights, and may use regularization methods such as dropout or weight decay to prevent overfitting. The training process may include data augmentation steps, such as reordering bullet-point items or paraphrasing target sentences, to improve robustness. These training details ensure that the generative AI model generalizes to previously unseen bullet-point combinations and produces coherent and contextually appropriate sentences.

In one variation, the server executes an instance of the generative AI model locally on specialized hardware, such as a graphics processing unit or an accelerator, rather than via a remote service. In such a variation, the server manages local model loading from storage, memory allocation for model parameters, and scheduling of inference tasks. The server may implement batching of multiple prompt sentences to efficiently utilize hardware resources, reducing average inference latency per request. The server may also implement quantization or pruning techniques on the model parameters to reduce memory footprint and accelerate computation. These hardware-aware optimizations further reinforce that the system provides a technical improvement over generic natural-language handling.

In another variation, the server supports multiple model configurations and dynamically selects an appropriate model or parameter set based on characteristics of the structured input, such as the number of bullet-point items or the detected language. For shorter input lists, the server may choose a smaller model with lower computational cost, while for longer or more complex bullet-point lists, the server may invoke a larger model to improve quality. The server records response metrics, such as generation time and user edit distances, and uses these metrics to refine model-selection policies. This adaptive behavior optimizes the trade-off between computational cost and output quality, which is a technical performance consideration specific to computing environments.

The described system can be applied not only to customer support inquiries but also to other domains requiring structured-to-natural-language transformation. For example, the server may receive bullet-point specifications for technical issues, legal questions, or medical inquiries, and generate standardized forms or reports. In each such application, the server processes structured input using the same deterministic prompt-creation and quality-checking mechanisms, thereby providing consistent improvements in processing speed, accuracy, and data management.

Because the server uses a defined set of data structures, prompt sentence patterns, quality-checking algorithms, and classification models, the system goes beyond mere automation of human drafting. The server restructures user intent into machine-optimized representations, manages data flow across networked modules in a resource-efficient manner, and improves the operation of both the generative AI model and downstream processing systems. Consequently, the invention provides a concrete technological solution that enhances computing performance in terms of response speed, resource utilization, and processing accuracy.

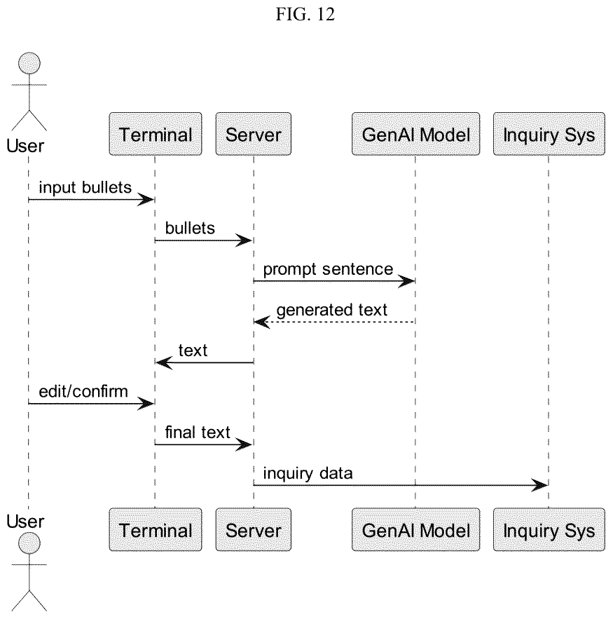

The following describes the processing flow using FIG. 12.

### Step 1

The terminal displays an input screen that includes one or more text input fields for bullet-point items. The terminal initializes an internal list data structure to store the bullet-point strings. The input of this step is user keystrokes or touch input, and the output is an in-memory list of bullet-point strings. The terminal captures each input event, inserts or updates the corresponding string element in the list, and performs local validation such as checking that each element is non-empty and within a maximum character length.

### Step 2

The user operates the terminal to complete entry of the bullet-point items that represent requests, questions, or unclear points. The user visually confirms the displayed bullet-point list and triggers a send operation by activating a button or equivalent control. The input of this step is the bullet-point list shown on the terminal display, and the output is a user confirmation event. The user thereby causes the terminal to proceed to transmission processing for the structured bullet-point data.

### Step 3

The terminal generates a structured request object that contains the validated bullet-point list and associated metadata such as a language code and a user identifier. The input of this step is the in-memory list of bullet-point strings and metadata from the terminal's configuration, and the output is a serialized representation such as a JSON text string. The terminal performs data formatting operations that map each bullet-point element to a field in the structured object, then serializes this object into a byte sequence suitable for network transmission.

### Step 4

The terminal transmits the serialized bullet-point data to the server via a communication network using a request message. The input of this step is the serialized request object, and the output is a network packet stream addressed to the server. The terminal invokes an HTTP client component to encapsulate the serialized data into a protocol-compliant request, sets headers such as a content type and an authentication token, and sends the data through a network interface such as Wi-Fi or a mobile communication module.

### Step 5

The server receives the request message from the terminal and parses the serialized data into internal data structures. The input of this step is the network packet stream carrying the structured bullet-point data, and the output is a server-side representation of the bullet-point list and metadata in main memory. The server performs protocol decoding to extract the request body, applies a parser to convert the serialized representation back into a list or array of text strings, and validates each element for type, length, and encoding conformity.

### Step 6

The server normalizes each bullet-point string and stores the normalized list as structured data. The input of this step is the raw list of bullet-point strings parsed at the server, and the output is a normalized list suitable for prompt construction. The server applies text-processing routines to remove leading and trailing whitespace, unify character encodings, adjust punctuation, and optionally convert full-width and half-width characters according to predefined rules. The server writes the normalized list and associated metadata to volatile memory and optionally to persistent storage for logging.

### Step 7

The server constructs a prompt sentence by combining an instruction segment with the normalized bullet-point items using a deterministic rule. The input of this step is the normalized bullet-point list and a prompt template stored in configuration data, and the output is a single text string that serves as the prompt sentence. The server concatenates the instruction segment and the list elements using delimiters such as commas or conjunctions, and may embed the bullet-point content into a fixed template. For example, the server generates a prompt sentence such as: “Please generate an inquiry sentence based on the following bullet points: checking product availability, requesting information on return procedures.”

### Step 8

The server determines generation parameters for the generative AI model and packages the prompt sentence and parameters into a model request. The input of this step is the constructed prompt sentence and configuration values such as temperature, maximum token count, and sampling strategy, and the output is a model-specific request structure. The server assigns concrete numeric values to these parameters, inserts them into a request object along with the prompt sentence, and serializes this object into a format required by the model interface.

### Step 9

The server transmits the model request containing the prompt sentence to the generative AI model through a model interface. The input of this step is the serialized model request, and the output is a model-side processing job scheduled on the generative AI model infrastructure. The server calls a network or library interface function, passes the serialized request, and sends the data over a secure channel. The server then waits for a response while optionally managing timeouts and retries.

### Step 10

The generative AI model processes the received prompt sentence using an internal neural network architecture. The input of this step is the prompt sentence and generation parameters, and the output is a sequence of tokens representing a generated natural-language sentence. The generative AI model tokenizes the prompt sentence into discrete tokens, maps tokens to numerical identifiers, and propagates the identifiers through a stack of transformer layers that perform linear transformations, attention computations, and non-linear activations. The generative AI model computes, at each output position, a probability distribution over the vocabulary, selects a next token according to the configured sampling method, and repeats this token generation until termination criteria are met.

### Step 11

The server receives the generated token sequence and converts it into a natural-language sentence string. The input of this step is the model response that contains the sequence of output tokens or text segments, and the output is a single text string corresponding to the generated sentence. The server decodes tokens into characters using the model's vocabulary mapping or directly extracts the text field if the model returns text. The server then combines the segments to form the complete sentence for further processing.

### Step 12

The server performs string-formatting processing and quality-checking processing on the generated natural-language sentence. The input of this step is the raw generated sentence string, and the output is a standardized sentence string accompanied by a quality status. The server executes operations such as trimming whitespace, normalizing line breaks, unifying punctuation, and optionally appending or removing fixed phrases. The server then evaluates the sentence against predetermined criteria by checking length limits, non-emptiness, character set conformity, and absence of prohibited expressions.

### Step 13

The server decides whether the generated sentence passes the quality-checking processing and, if necessary, repeats generation. The input of this step is the formatted sentence and the quality status, and the output is either an approved sentence or a decision to request regeneration. If any quality criterion fails, the server may adjust one or more generation parameters, such as reducing maximum tokens or changing temperature, and send a new model request with the original prompt sentence. If all criteria are satisfied, the server flags the sentence as approved for presentation to the user.

### Step 14

The server transmits the approved natural-language sentence to the terminal for display in an editable region. The input of this step is the approved sentence string and associated identifiers, and the output is a response message sent over the network to the terminal. The server constructs a response object including the sentence and status information, serializes it, and sends it through an application-level protocol. The server also updates server-side logs to record that the sentence has been delivered for user review.

### Step 15

The terminal receives the approved natural-language sentence and renders it in an editable display region. The input of this step is the network response carrying the sentence, and the output is a text buffer in client memory that is visually presented to the user. The terminal parses the response, extracts the sentence string, assigns it to the text area's underlying data model, and instructs the UI framework to redraw the display region with the sentence content.

### Step 16

The user reviews the displayed natural-language sentence and decides whether to modify it. The input of this step is the visible sentence rendered on the terminal display, and the output is either an unchanged sentence accepted by the user or a sequence of edit commands. The user inspects the content, style, and politeness level, and either opts to keep the sentence as is or applies text edits to adjust wording, add information, or remove unnecessary parts.

### Step 17

The terminal captures the user's editing operations and updates the local text buffer accordingly. The input of this step is the sequence of edit commands generated by keystrokes or touch gestures, and the output is an updated version of the sentence stored in memory. The terminal applies insertion, deletion, and replacement operations to the character string using its text-editing engine and maintains cursor position and selection ranges. The terminal may also measure the edit distance between the original sentence and the current version for later analysis.

### Step 18

The user completes editing and initiates submission of the final sentence. The input of this step is the current state of the edited sentence on the terminal, and the output is a user-initiated submission event. The user activates a confirmation control, such as a “Send” button, indicating that the sentence in its present form should be treated as a finalized inquiry.

### Step 19

The terminal packages the final sentence and related metadata into a structured submission object. The input of this step is the final text buffer and identifiers such as user ID and original bullet-point list ID, and the output is a serialized submission payload. The terminal constructs a data structure that includes the corrected sentence, the source bullet-point items, and contextual information, and serializes this structure into a text form suitable for network transfer.

### Step 20

The terminal transmits the final submission payload to the server. The input of this step is the serialized submission payload, and the output is a network message destined for the server's submission endpoint. The terminal uses an HTTP or similar client component to send the payload, setting appropriate headers and handling any necessary authentication or encryption.

### Step 21

The server receives the final sentence submission and registers it as inquiry information in persistent storage. The input of this step is the network message carrying the final sentence and metadata, and the output is a stored record in a database or other storage unit. The server parses the submission payload, verifies that the final sentence is present and valid, and writes a record including the final sentence, the original bullet-point list, user identifiers, timestamps, and a processing status into a structured data repository.

### Step 22

The server optionally classifies the inquiry based on the final sentence using a classification model or a generative AI model. The input of this step is the stored final sentence and any relevant feature data, and the output is an assigned inquiry category. The server converts the sentence into a numerical or symbolic representation suitable for the classifier, executes the classification algorithm to obtain category probabilities, and selects a category label that satisfies a configured confidence threshold. The server stores this category alongside the inquiry record.

### Step 23

The server determines a processing destination or processing priority in an inquiry-processing system according to the assigned category. The input of this step is the inquiry category and system routing rules, and the output is a routing decision specifying a destination queue, module, or priority level. The server consults a rule table or policy engine, maps the category to a routing target and priority, and updates the inquiry record with this routing information.

### Step 24

The server outputs the inquiry data, including the final sentence and routing information, to the inquiry-processing system or information-retrieval system. The input of this step is the enhanced inquiry record containing text, metadata, and category, and the output is a transmission to a downstream system that will process the inquiry. The server constructs a data structure expected by the downstream system, serializes it, and sends it over an inter-system communication interface. The server then updates the status of the inquiry record to indicate that downstream processing has been initiated.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional text generation systems using a generative AI model receive a user's free-form request and directly pass that request to the model to obtain an output text. Such systems suffer from several technical problems in the context of computer implementation. First, because the user's request is handled as an unstructured string, the processor cannot accurately capture the logical structure or intent of the request, which leads to unstable model behavior and increased variance in generation quality. As a result, the system must repeatedly invoke the generative AI model, consuming excessive computational resources and network bandwidth, and degrading throughput and latency from the standpoint of computer performance.

Second, in many existing systems, user editing of the generated text remains on the client side and is not fed back into the server-side processing. The processor therefore cannot leverage concrete post-generation edit operations as machine-readable signals, and cannot adapt the construction of prompt sentences or the generation conditions of the generative AI model. This prevents the system from learning from actual usage patterns and from incrementally optimizing the token sequences supplied to the generative AI model, which in turn limits the efficiency and accuracy of server-side inference processing over time.

Third, conventional architectures often treat generated texts as transient results and do not systematically associate finalized texts with identification information, time information, and their originating requests in a server-side storage device. This lack of structured persistence prevents efficient retrieval and reuse of prior outputs, forcing repeated generation of similar texts for similar requests. Consequently, the processor repeatedly performs redundant inference operations on the generative AI model, which increases computational load and energy consumption and reduces the scalability of the overall system when deployed on shared computing infrastructure.

In view of the foregoing, there is a need for a computer-implemented system and server-side processing architecture that (i) transforms an unstructured user request into structured information prior to model invocation, (ii) captures and utilizes user editing behavior as learning information to refine prompt sentences and generation conditions, and (iii) persistently stores finalized texts together with associated metadata for efficient retrieval. Such a system should improve the technical operation of computers executing generative AI workloads by reducing unnecessary inference calls, stabilizing generation behavior, and enabling adaptive control of the generative AI model based on concrete user interaction data.

The specific processing by the specific processing unit 290 of the data processing device 12 in Example 2 is realized by the following means.

The present invention provides a server comprising a processor configured to acquire request information input by a user via a terminal, convert the request information into structured information including a plurality of items by using a natural language processing algorithm, construct, on the basis of the structured information and the request information, a prompt sentence for instructing a generative AI model to generate a natural language text, and input the prompt sentence to the generative AI model so as to cause the generative AI model to generate the natural language text; transmit the natural language text generated by the generative AI model to the terminal via a communication network and cause the terminal to display the natural language text to the user; acquire, from the terminal, an editing operation performed by the user on the natural language text, the editing operation including addition, deletion, or modification of a character string, update the natural language text in accordance with the editing operation, and acquire an updated version of the natural language text as a finalized text; store the finalized text and the request information in an information storage device in association with identification information and time information so that the finalized text is subsequently searchable and retrievable on the basis of the identification information; and acquire a history of the editing operation on the natural language text and accumulate the history as learning information used to sequentially update at least one of a configuration of the prompt sentence to be input to the generative AI model and a generation condition of the generative AI model. This enables the server to technically improve computer-implemented text generation by structurally pre-processing user requests before inference, adaptively optimizing prompt sentences and model generation parameters based on concrete user edit histories, and reducing redundant generative AI invocations through server-side storage and reuse of finalized texts, thereby enhancing the efficiency, stability, and scalability of the underlying computing resources.

The term “request information” refers to character string data representing a user's instruction, requirement, question, or description, which is input via an input interface of a terminal and transmitted to the server for processing.

The term “terminal” refers to an information processing apparatus, such as a computing device including an input unit, a display unit, and a communication unit, which is configured to send request information to a server and present a natural language text to a user.

The term “natural language processing algorithm” refers to a computational procedure executed by a processor to analyze and transform natural language text, including at least one of tokenization, part-of-speech tagging, syntactic parsing, semantic analysis, or information extraction.

The term “structured information” refers to data obtained by organizing unstructured request information into a machine-interpretable format comprising a plurality of items, fields, or elements, each representing a separated component of the user's request.

The term “item” refers to an individual element of structured information that expresses a specific aspect, constraint, condition, or sub-requirement included in the request information.

The term “prompt sentence” refers to a text sequence formulated for input to a generative AI model, the text sequence including information for guiding the generative AI model to generate a natural language text responsive to the request information.

The term “generative AI model” refers to a trained machine learning model, such as a neural network-based language model, configured to generate natural language text on the basis of an input sequence including a prompt sentence.

The term “natural language text” refers to a sequence of characters forming one or more sentences in a human language, generated by the generative AI model in response to a prompt sentence.

The term “communication network” refers to an arrangement of communication links and nodes, including at least one of a wired network, a wireless network, or the Internet, which enables data transmission between a server and a terminal or another external apparatus.

The term “user interface” refers to a software-implemented presentation and input environment, including at least one of a graphical user interface or a web interface, through which a user views a natural language text and performs operations such as confirmation and editing.

The term “editing operation” refers to user-initiated manipulation of a displayed natural language text, including at least one of insertion, deletion, or modification of characters, words, phrases, or sentences.

The term “finalized text” refers to a version of the natural language text obtained after completion of at least one editing operation, which is treated as a confirmed output to be stored or transmitted.

The term “information storage device” refers to a storage resource including at least one of a semiconductor memory, a magnetic storage, or an optical storage, configured to persistently store data such as request information, finalized text, and associated metadata.

The term “identification information” refers to data enabling unique or specific identification of stored information, including at least one of a record identifier, a user identifier, or a combination thereof.

The term “time information” refers to temporal data associated with processing or storage events, including at least one of a timestamp indicating a generation time, an editing time, or a saving time of the natural language text.

The term “editing history” refers to log data representing a sequence of editing operations applied to a natural language text, including information on operation type, position, content before editing, and content after editing.

The term “learning information” refers to data used to modify or optimize at least one of a configuration of a prompt sentence or a generation condition of a generative AI model, the data including editing history or other user interaction records.

The term “generation condition” refers to a parameter or set of parameters controlling operation of a generative AI model, including at least one of a generation length, a sampling method, a temperature value, or a restriction on content or style.

The term “external information processing apparatus” refers to an information processing system other than the server, which is configured to receive inquiry information via a communication network and perform at least one of storage, analysis, or response generation based on the inquiry information.

The term “inquiry information” refers to data transmitted from the server to an external information processing apparatus, the data including at least a finalized text used as content of a query, request, or report.

The term “confirmation operation” refers to a user input indicating that the user has reviewed and approved a finalized text, the input being performed through the user interface by at least one of selecting a confirmation control, activating a button, or issuing an equivalent command.

In one embodiment, a server, a terminal, and a user cooperate to implement the claimed system. The server includes at least one processor, a memory, a network interface, and a non-transitory storage device. The processor may be implemented by a general-purpose central processing unit or by a combination of a central processing unit and an accelerator such as a graphics processing unit. For example, the server may use a multi-core x86-compatible processor and a graphics processing unit supporting a parallel computation framework. The memory may include a volatile semiconductor memory, and the storage device may include a magnetic disk device or a solid-state storage device. The server executes an operating system and middleware such as a web server framework and a machine learning runtime. The server further executes application software that implements the functions described below.

The terminal is an information processing apparatus including at least one processor, a display unit, an input unit, and a communication unit. For example, the terminal may be a smartphone, a tablet, or a personal computer running a general-purpose operating system and a web browser or native application. The terminal provides a graphical user interface that allows the user to input a prompt sentence, to view a generated natural language text, and to perform editing operations on the generated natural language text. The terminal communicates with the server via a communication network, for example through a wireless local area network, a cellular network, or a wired network.

The user operates the terminal to input request information. The user may input the request information in the form of a prompt sentence describing the desired content or style of a text. For example, the user may input one of the following prompt sentences:

“Please create a text that explains the features of a new product.”

“Generate a formal business description of a new cloud service, including its main functions and benefits.”

“Write a concise product introduction highlighting eco-friendly features and long-term cost savings.”

“Create marketing copy for a smartphone app that helps users manage their daily tasks efficiently.”

“Draft a technical overview of an AI-powered analytics tool for presentation to IT managers.”

The terminal converts the user's key operations on a keyboard or touch panel into character codes and stores the resulting string as request information in a working memory. The terminal then transmits the request information to the server via the communication network using a communication protocol such as a hypertext transfer protocol over a transport control protocol and an internet protocol. The request information is encapsulated as data in the payload of a communication message.

The server receives the request information through the network interface and stores it in the memory. The server then executes a natural language processing algorithm on the request information in order to convert the unstructured string into structured information including a plurality of items. In one embodiment, the server uses a tokenization module to segment the request information into tokens corresponding to words or subword units. The server then performs syntactic and semantic analysis using a natural language processing library. For example, the server may apply part-of-speech tagging, dependency parsing, and named-entity recognition algorithms implemented in a natural language processing framework.

The server represents the structured information as a data structure, for example as a list of item records. Each item record may include fields such as an item type, an item content, a priority level, and one or more constraint flags. The item type may distinguish between a topic term, a required feature, a target audience, a desired tone, or other semantic categories extracted from the request information. The server stores the structured information in the memory in association with an identifier of the corresponding request information.

By converting the free-form request information into the structured information, the server aligns the input to a format optimized for generation control of the generative AI model. This technical conversion allows the server to apply rule-based or learned weighting to different items at the time of prompt construction, thereby reducing variance in model behavior and increasing reproducibility of the generated natural language text. Because the server can isolate and explicitly encode key constraints, the server can reduce the need for repeated trial-and-error calls to the generative AI model, which improves processing throughput and reduces consumption of computational resources.

The server constructs a prompt sentence for the generative AI model by combining the structured information with the original request information. In one embodiment, the server uses a template-based prompt constructor that maps each item type to a predefined textual pattern. For example, the server may convert a topic item into a sentence clause specifying the subject matter, convert a tone item into a clause specifying the style, and convert a target audience item into a clause specifying the readership. The server concatenates these clauses in a predetermined or adaptively learned order and optionally appends the original request information as a natural language description.

In an alternative embodiment, the server uses a rule engine that selects different prompt templates depending on item combinations. For instance, when the structured information includes both an eco-friendly feature item and a cost-saving item, the server may select a template that explicitly instructs the generative AI model to emphasize sustainability and economic benefits in that order. This non-conventional prompt construction procedure differs from human manual drafting, because it operates over machine-interpretable item records and applies deterministic or learned transformation rules to generate the prompt sentence.

The server inputs the constructed prompt sentence into a generative AI model. In one embodiment, the generative AI model is a transformer-based neural network trained on large-scale text data. The generative AI model includes an embedding layer, a plurality of self-attention layers, and an output projection layer. The server converts the prompt sentence into token identifiers using a tokenizer associated with the generative AI model. The server then supplies the token identifiers to the generative AI model executed on the graphics processing unit. The graphics processing unit performs matrix multiplications and non-linear activation computations required for self-attention and feed-forward operations in each layer.

In one training configuration, the generative AI model has been trained using a supervised learning method with a cross-entropy loss function. During training, the server has updated weights of the model using a gradient-based optimization algorithm. The server may have performed data augmentation on training sentences, such as paraphrasing or synonym replacement, to improve robustness. The use of such a neural architecture with attention mechanisms enables the model to maintain long-range dependencies in the prompt sentence and to generate contextually appropriate natural language text.

At inference time, the server supplies the prompt sentence token sequence to the generative AI model together with generation conditions. The generation conditions may include parameters such as a maximum number of tokens to generate, a sampling method, a sampling temperature, and one or more content constraints. The server controls these parameters programmatically. For example, the server may set a low sampling temperature and use a greedy or top-k selection algorithm when the structured information indicates a need for high factual stability. Conversely, the server may set a higher sampling temperature when the structured information indicates a creative marketing text requirement.

The generative AI model computes a probability distribution over a vocabulary for each next token and the server incrementally selects next tokens according to the selected decoding algorithm. The server decodes the resulting token sequence back into a character string, thus obtaining the generated natural language text. The server then transmits the generated natural language text to the terminal through the communication network. The terminal receives the generated natural language text and displays it on the display unit, for example in an editable text area of the graphical user interface.

The user reviews the generated natural language text and may perform editing operations. The user may add a sentence, delete an unnecessary phrase, or modify expressions. For example, if the server generated the sentence “This new product is equipped with the latest technology and provides a personalized experience tailored to the user's needs,” the user may add “In addition, because it uses environmentally friendly materials, it contributes to a sustainable society.” The terminal captures each editing operation as event data including at least the operation type, cursor position, and affected character sequence before and after the operation. The terminal transmits the editing event data to the server.

The server receives the editing event data and stores it as an editing history associated with the original generated natural language text and the corresponding structured information. The server uses this editing history as learning information to adaptively update the prompt construction procedure and the generation conditions. For example, when the editing history repeatedly indicates that users add information about environmental features following product descriptions, the server may modify an internal rule such that the prompt sentence explicitly instructs the generative AI model to include an environmental impact section for similar future requests. Alternatively, the server may adjust weight parameters in a prompt selection module, using a supervised learning algorithm that treats edits as feedback signals indicating missing or misplaced content.

By using detailed editing histories in this manner, the server implements a feedback loop that optimizes the computational path leading to the generated natural language text. This approach is not a mere automation of human editing, because the server analyzes patterns over large numbers of fine-grained edit operations and converts them into numerical adjustments of parameters controlling prompt construction and generation conditions. As a result, the server gradually reduces the discrepancy between the initial generated natural language text and typical user-edited finalized texts. This leads to fewer required editing operations for subsequent requests, which reduces the total number of generative AI inferences and the average amount of user interaction time. The technical effect includes lower processing latency, reduced utilization of graphics processing unit cycles, and decreased communication load between the server and the terminal.

When the user completes editing, the user indicates confirmation through the user interface. The terminal sends the finalized text and confirmation information to the server. The server then stores the finalized text and the corresponding request information in the storage device together with identification information and time information. The server may implement the storage using a relational data structure or a document-oriented data structure. For example, the server may store records including fields such as a text identifier, a user identifier, a request hash value, a timestamp, the finalized text, and associated structured information.

This structured storage allows the server to perform efficient searches based on identification information, request similarity, or temporal criteria. When a future request is similar to a past request, the server can retrieve an existing finalized text or use it as a candidate for partial reuse. In one example, the server may compute a similarity measure between the structured information of a new request and that of stored requests and, if the measure exceeds a threshold, may present a previously finalized text as a starting point instead of invoking the generative AI model from scratch. This reuse reduces redundant inference calls and lowers computational load. The server thus improves data management and overall computation efficiency of the generative AI workload.

In another embodiment, the server transmits the finalized text as inquiry information to an external information processing apparatus such as a separate server system. The server controls transmission conditions such that the finalized text is automatically transmitted only when a confirmation operation has been accepted from the user. This control avoids unnecessary external communication and ensures that only user-approved data is sent over the communication network. By coupling the confirmation operation with transmission logic, the server reduces erroneous or premature network traffic, thereby reducing network bandwidth consumption and potential processing load on the external apparatus.

From the perspective of computer technology, the described system improves operation of the server and the generative AI model by implementing specific data structures and processing flows that are not conventional human mental processes. The conversion from request information to structured information enables algorithmic optimization of prompt generation and model parameter setting. The capture and analysis of editing histories as learning information introduces a technical feedback mechanism that modifies internal control parameters of the prompt constructor and generation conditions. The persistent storage of finalized texts with identification and time information enables cache-like reuse and targeted retrieval that reduces redundant computation.

These mechanisms yield measurable technical effects such as faster response times, lower average number of generation iterations per request, and reduced variance in output quality. By shaping the input representation and control parameters of the generative AI model based on structured information and empirical editing histories, the server performs a specialized computation that is distinct from mere business rule automation. The system leverages the generative AI model as a computational engine whose input space and operating conditions are adaptively optimized by the server to improve computing efficiency, stability, and resource utilization.

Various modifications and alternative embodiments are possible. For example, the server may implement the natural language processing algorithm using different libraries or models, such as statistical parsers or smaller transformer encoders dedicated to item extraction. The generative AI model may be deployed locally on the same physical machine as the server or executed on a separate inference cluster accessed via a model serving interface. The editing history analysis may use rule-based logic, supervised machine learning, or reinforcement learning to update prompt construction parameters. The storage structure may be a keyed data store, a distributed file system, or a relational database, as long as identification information and time information are associated with the finalized texts in a retrievable manner. The terminal may be implemented as a web client, a native client, or another type of user interface device, as long as it is capable of sending request information, displaying natural language text, and reporting editing operations back to the server.

In all such embodiments, the server, the terminal, and the user cooperate so that the server executes structured processing of the request information, adaptive control of the generative AI model via the prompt sentence and generation conditions, and optimized storage and reuse of finalized texts, thereby improving the technical performance of computer systems executing generative AI model workloads.

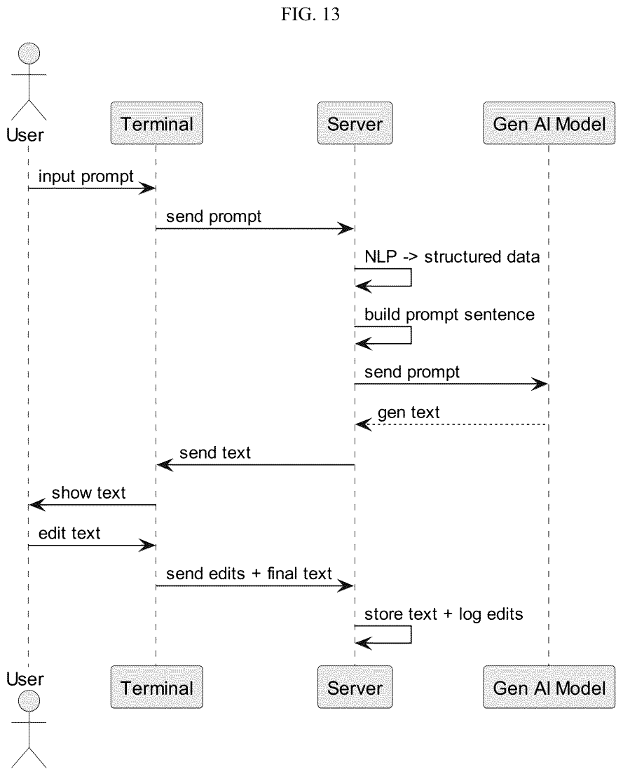

The following describes the processing flow using FIG. 13.

### Step 1

The user operates the terminal to input request information. The user uses a keyboard, touch panel, or voice input interface of the terminal to enter a prompt sentence as text data, such as “Please create a text that explains the features of a new product.” The terminal receives this input as a sequence of characters (input) and stores the sequence in a working memory as a string object. The terminal performs basic validation and encoding (for example, converting key events to a UTF-8 encoded string) and outputs the validated request information to an internal communication module.

### Step 2

The terminal transmits the request information to the server. The terminal takes the stored string (input), encapsulates it in a request message structure together with metadata (such as a user identifier and a timestamp), and serializes the structure into a data format such as JSON. The terminal then uses a communication stack (for example, TCP/IP with HTTPS) to send the serialized data as the payload of a network packet to a designated network address of the server. The output of this step is a network message containing the request information delivered to the server.

### Step 3

The server receives the request information from the terminal. The server accepts the incoming network packet via a network interface as binary data (input), passes it through a communication stack, and reconstructs the application-level message. The server then parses the serialized format (for example, JSON) to extract the request information string and associated metadata. The server stores the extracted request information in a memory region as a text buffer and outputs the raw request string and initial metadata to subsequent natural language processing modules.

### Step 4

The server converts the request information into structured information including a plurality of items. The server takes the raw request string (input) and applies a natural language processing algorithm composed of tokenization, part-of-speech tagging, syntactic parsing, and semantic role labeling. Using these results, the server identifies semantic units such as topic, required features, target audience, and tone, and constructs an internal data structure (for example, a list or array of item records). Each item record includes fields for item type, item content, and optional constraint flags. The server outputs the structured information as a machine-interpretable representation linked to the original request.

### Step 5

The server constructs a prompt sentence for a generative AI model based on the structured information and the request information. The server receives, as input, the structured information and the original request string. The server then applies a prompt construction algorithm that maps each item type to a specific template fragment and orders these fragments according to predefined rules or learned weights. The server concatenates the fragments, optionally appends the original request sentence as clarification, and generates a complete prompt sentence. The output of this step is a constructed prompt sentence string prepared for input to the generative AI model.

### Step 6

The server converts the prompt sentence into token identifiers suitable for the generative AI model. The server takes the prompt sentence string (input) and applies a tokenizer associated with the generative AI model. The tokenizer segments the text into subword units or tokens and maps each token to a numerical identifier using a vocabulary table. The server collects the sequence of token identifiers into an array or tensor structure. The output is a token sequence representing the prompt sentence, ready to be processed by the generative AI model.

### Step 7

The server executes the generative AI model using the token sequence as input to generate a natural language text. The server feeds the token sequence (input) into a neural network implementation of a generative AI model, such as a transformer-based language model, running on a processor or an accelerator. The server performs forward propagation through embedding layers, multiple attention layers, and feed-forward layers to compute probability distributions for subsequent tokens. Based on generation conditions (such as maximum length and sampling strategy), the server iteratively selects next token identifiers and appends them to an output sequence. The output of this step is an array of token identifiers representing the generated natural language text.

### Step 8

The server converts the generated token sequence back into a natural language text string. The server takes the generated token identifiers (input) and applies the inverse tokenizer (detokenizer), which maps each identifier back to its corresponding subword unit and concatenates the units into a coherent text string. The server may remove special control tokens and normalize whitespace. The output is a generated natural language text string that responds to the original prompt sentence.

### Step 9

The server transmits the generated natural language text to the terminal. The server takes the generated text string and associated identifiers (input), encapsulates them into a response message structure, and serializes the structure into a format such as JSON. The server then sends the serialized data via the communication stack over the communication network. The output of this step is a network message containing the generated natural language text, delivered to the terminal.

### Step 10

The terminal receives and displays the generated natural language text to the user. The terminal obtains the response message from the network interface as binary data (input), parses the serialized format to extract the generated text string, and stores it in a display buffer. The terminal updates the graphical user interface by rendering the text in an editable area, for example, a text box on the screen. The output is a visual representation of the generated natural language text on the display unit, accessible for user review and editing.

### Step 11

The user performs editing operations on the generated natural language text. The user observes the displayed text (input in human-perceptual form) and uses the keyboard or touch panel to add, delete, or modify parts of the text. For example, the user may insert the sentence “In addition, because it uses environmentally friendly materials, it contributes to a sustainable society.” The terminal converts the user's actions into editing events with operation type, position, and content data, applies the edits to the local text buffer, and outputs the updated text string and a set of editing event records.

### Step 12

The terminal transmits the editing event records and the updated text to the server. The terminal takes the updated text and editing events (input), packages them into a message together with identifiers linking them to the original generation instance, and serializes the message. The terminal sends the serialized data via the communication network. The output is a network message including the finalized or intermediate text and a detailed editing history, delivered to the server.

### Step 13

The server updates the generated natural language text and accumulates the editing history as learning information. The server receives the editing events and updated text (input), verifies their consistency with the originally generated text, and stores them as an editing history record associated with the request and structured information. The server then analyzes the editing history, for example by counting recurring addition patterns or measuring typical correction positions, and updates internal control parameters of the prompt construction algorithm or generation conditions. The output is an updated finalized text stored in memory and an updated set of control parameters reflecting observed user editing behavior.

### Step 14

The server stores the finalized text, the request information, and associated metadata in an information storage device. The server takes the finalized text, original request information, structured information, identification information, time information, and possibly similarity indices (input) and constructs a database record or document. The server writes this record to persistent storage using a storage interface, such as a database management system API. The output is a stored entry that can be subsequently retrieved using the identification information or other query criteria.

### Step 15

The server optionally transmits the finalized text as inquiry information to an external information processing apparatus. The server takes the finalized text and confirmation status (input), checks that a confirmation operation from the user has been received, and, if the condition is satisfied, encapsulates the finalized text into an inquiry message addressed to the external apparatus. The server sends this message through the communication network. The output is an externally delivered inquiry containing the user-approved finalized text, which can be processed by the external apparatus for further analysis, logging, or action.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented systems that assist users in drafting inquiry texts or other communications typically accept free-form natural language input and apply a text generation model in a single pass. Such systems treat the user's input as a static string and do not decompose the input into structured bullet-point items that explicitly capture the user's distinct intentions. As a result, the systems often produce generated text that is verbose, off-topic, or misaligned with the user's underlying objectives. This leads to additional manual editing effort on the terminal side and inefficient use of computing resources on the server side, because the text generation model is repeatedly invoked without a precise representation of the user's requirements.

Furthermore, known systems generally do not tightly integrate emotion analysis and prompt construction at the system level. Emotion or sentiment analysis, if present at all, is typically used only for downstream analytics and not as a real-time control signal that parametrizes the prompt sentence supplied to a generative AI model. Consequently, the generated text fails to adapt its tone, degree of urgency, or politeness to the user's emotional state, and various re-generation and manual correction cycles are needed. This increases latency, consumes additional network bandwidth, and reduces the determinism and predictability of server-side computation.

In addition, existing systems tend to treat user editing as a purely local operation on the terminal. Edits performed via keyboard, pointing device, or voice input are not fed back into the text generation pipeline in a structured manner. The server does not re-analyze the edited text, does not reconstruct a refined prompt sentence, and does not use the generative AI model to produce an improved version taking account of both the new text and updated emotion information. As a result, the system cannot converge efficiently to a high-quality, user-approved text with minimal user interaction and minimal server-side processing cycles.

There is also a lack of coordinated real-time update mechanisms that link user edits and server-side processing. Existing architectures do not specify how to update the displayed text in real time based on edit operations while simultaneously managing server-side re-generation and selection of competing versions (machine-generated and user-edited). This leads to fragmented workflows, where the user interface, emotion analysis, prompt construction, and generative AI model invocation are loosely coupled and difficult to optimize as an integrated computer-implemented pipeline.

Accordingly, there is a need for an improved computer-implemented system and server-side processing method that: (i) converts user natural language input into structured bullet-point data to more accurately represent user requirements; (ii) constructs prompt sentences for a generative AI model that are explicitly conditioned on both the structured content and emotion analysis of the user input; (iii) supports user editing via pointing device operations and speech recognition-based commands with real-time display updates; and (iv) re-applies the emotion analysis and prompt construction to edited text to generate improved versions, while allowing the user to select a final version that can be transmitted as inquiry information. Such an integrated approach can improve the functioning of the computer system itself by reducing unnecessary model calls, lowering latency, and increasing the quality and stability of generated text output.

The specific processing by the specific processing unit 290 of the data processing device 12 in Application Example 2 is realized by the following means.

The present invention provides a server comprising a processor configured to receive user input information expressed in a natural language from a terminal, convert the input information into structured text data in a bullet-point format including a plurality of items by executing a language processing algorithm, generate a prompt sentence including sentence generation conditions reflecting emotion information of the user based on the structured text data in the bullet-point format and the emotion information estimated by an emotion analysis algorithm, and input the prompt sentence to a generative AI model so as to cause the generative AI model to generate text data in a natural language, display via a user interface the text data generated by the generative AI model and provide an editing tool that enables the user to confirm and modify the text data based on an operation of a pointing device or based on an editing operation derived from voice input acquired by a speech recognition algorithm, update and display the text data in real time according to a result of the editing operation, analyze edited text data again by using the emotion analysis algorithm, regenerate the prompt sentence based on an analysis result and input the regenerated prompt sentence to the generative AI model so as to automatically generate an improved version of the text data, and control the user interface to present at least one of the text data automatically generated by the generative AI model and the text data edited by the user so that the at least one of the text data is selectable as a final version, and to transmit text data selected as the final version as inquiry information to an external information processing apparatus via a communication network. This enables the computer system to more efficiently transform user natural language input into high-quality, emotionally appropriate final text by structurally organizing the input, dynamically conditioning prompt sentences on emotion analysis, tightly integrating server-side generation with client-side editing operations, reducing redundant model invocations, and improving overall latency and resource utilization in a technically coordinated text generation pipeline.

The term “processor” refers to a hardware or virtual computing unit, such as a central processing unit, graphics processing unit, or other execution core, configured to execute instructions of a program to perform the steps described herein.

The term “user” refers to a human operator or an entity that interacts with the system by providing input information and by reviewing or editing generated text data via a user interface.

The term “input information” refers to content provided by the user, expressed in a natural language, and including at least one request, question, or unclear point to be processed by the system.

The term “natural language” refers to a human language used for everyday communication, including but not limited to written sentences, phrases, or utterances in languages such as English, Japanese, or other human languages.

The term “language processing algorithm” refers to a software procedure or model configured to analyze natural language text and to perform operations such as tokenization, segmentation, normalization, or transformation into structured textual representations.

The term “structured text data” refers to text that has been organized into a predefined format, such as a data structure including separate fields, items, or annotations, so that individual elements of the text are explicitly identifiable and machine-processable.

The term “bullet-point format” refers to a representation of structured text data in which multiple items are separated into discrete elements, such as list entries or records, each corresponding to a respective component of the user's input information.

The term “emotion analysis algorithm” refers to a software procedure or model configured to evaluate natural language text and to estimate an emotional state, sentiment, or affective attribute associated with the text or with the user.

The term “emotion information” refers to data representing one or more emotional states, sentiments, or affective attributes, such as urgency, dissatisfaction, politeness, or neutrality, associated with the user or the user's input.

The term “sentence generation conditions” refers to parameters, constraints, or control information that influence how a generative model produces text, including conditions related to tone, politeness, urgency, length, or style, and including conditions derived from emotion information.

The term “prompt sentence” refers to an instruction text or input string provided to a generative AI model, the instruction text specifying at least part of the content, style, or conditions under which the generative AI model is to generate natural language text.

The term “generative AI model” refers to an artificial intelligence model that, when provided with input such as a prompt sentence, probabilistically generates natural language text as output based on learned parameters.

The term “text data” refers to machine-readable data representing characters, words, sentences, or documents in a natural language, including data that has been generated by a generative AI model or edited by a user.

The term “user interface” refers to hardware and software components that present information to the user and receive operations from the user, including but not limited to graphical user interfaces, touch interfaces, or voice-based interfaces.

The term “editing tool” refers to software functionality provided through the user interface that allows the user to modify, insert, delete, or rearrange portions of text data by means of input operations.

The term “pointing device” refers to an input device or mechanism that enables a user to select, point to, or manipulate elements on a display, including but not limited to a mouse, touchpad, stylus, or touch-sensitive display.

The term “voice input” refers to audio data representing speech uttered by the user and captured by a sound input device, such as a microphone, for subsequent processing by a speech recognition algorithm.

The term “speech recognition algorithm” refers to a software procedure or model that converts voice input into corresponding text or control commands by recognizing spoken words and phrases.

The term “editing operation” refers to an action that alters text data, including inserting, deleting, replacing, or reordering characters, words, phrases, or sentences, where the action is triggered by a user input such as a pointing device operation or a voice-derived command.

The term “real time” refers to an operation or update that occurs with latency sufficiently low that the user perceives the system as responding without noticeable delay during an interactive editing session.

The term “improved version of the text data” refers to text data generated by the generative AI model based on a regenerated prompt sentence, the improved text data being modified relative to prior text data in view of updated emotion information or edited content.

The term “final version” refers to a version of text data that has been designated as complete for a particular interaction, typically by explicit selection or confirmation by the user through the user interface.

The term “inquiry information” refers to text data that represents a user's finalized communication, such as a question, request, or complaint, intended to be transmitted from the system to an external information processing apparatus.

The term “external information processing apparatus” refers to any computing system or device external to the claimed system, such as a server, service platform, or communication endpoint, that receives and processes the inquiry information.

The term “communication network” refers to a wired or wireless data transfer infrastructure, such as a local area network, wide area network, or public network, over which the system transmits and receives digital information.

In one embodiment, a server, a terminal, and a communication network cooperate to implement the claimed system. The server includes at least one hardware processor, a main memory, a non-volatile storage device, and a network interface controller. The terminal includes a display unit, an input unit such as a touchscreen or pointing device, a microphone, a local processor, and a communication interface. The server executes server-side programs that perform language processing, emotion analysis, prompt sentence generation, and interaction with a generative AI model. The terminal executes client-side programs that perform user interaction, local text handling, and communication with the server.

The server uses a general-purpose computing platform, for example a rack-mounted information processing apparatus equipped with a multi-core central processing unit, a graphics processing unit or tensor processing unit for neural network inference acceleration, volatile memory, and non-volatile storage. The server executes server-side software implemented, for example, in a programming language interpreter or runtime environment, an operating system, and one or more application frameworks. The server may employ a web framework such as a lightweight HTTP framework to implement an application programming interface endpoint that receives and returns structured data. The server may also use a neural network library such as a deep learning framework to execute a generative AI model and an emotion analysis model.

The terminal uses a portable or stationary information processing apparatus, such as a smartphone, a tablet computer, a laptop computer, a desktop computer, or a head-mounted display device. The terminal executes a client application implemented, for example, using a cross-platform mobile framework or a web browser running script code. The terminal presents a graphical user interface for text input, display of generated text, and editing operations. The terminal also provides access to a local audio subsystem including a microphone for capturing voice input.

The server stores a generative AI model as a set of numerical parameters representing a neural network. In one embodiment, the generative AI model has a transformer-based architecture including a stack of self-attention layers and feedforward layers. Each self-attention layer includes multiple attention heads, each attention head computing attention weights based on a scaled dot-product between query, key, and value vectors derived from token embeddings. The generative AI model processes a sequence of tokenized text corresponding to a prompt sentence and outputs a sequence of probability distributions over a vocabulary at each decoding step. The generative AI model uses a positional encoding scheme to represent token positions and uses layer normalization and residual connections between layers to stabilize training and inference.

The server stores an emotion analysis algorithm as a separate model. In one embodiment, the emotion analysis algorithm is implemented as a neural network classifier that maps text embeddings to emotion labels or scores. The server may obtain text embeddings using a pre-trained transformer encoder or a recurrent neural network. The classifier outputs a probability distribution over a set of emotion categories such as “urgent,” “dissatisfied,” “neutral,” or “polite,” and the server selects the category with the highest probability as the emotion information. Alternatively, the server may output a continuous value representing an urgency score or sentiment polarity.

The server trains the generative AI model and the emotion analysis model prior to deployment using a training dataset stored in a training storage unit. The server processes a large corpus of natural language text to train the generative AI model using a maximum likelihood objective. The server computes a cross-entropy loss between the model's predicted token distributions and the ground truth next tokens. The server updates the network weights by backpropagation and a gradient-based optimization algorithm such as stochastic gradient descent with adaptive learning rate. The server may apply data augmentation techniques such as synonym substitution, paraphrasing, and noise injection to increase robustness.

The server trains the emotion analysis model using labeled text data where each training example is annotated with one or more emotion labels. The server computes a classification loss, such as cross-entropy loss, between the predicted emotion distribution and the ground truth label, and updates the model parameters via backpropagation. The server may also fine-tune a pre-trained language model on the labeled emotion dataset to improve classification accuracy.

The terminal generates input information based on user operations. The user enters one or more requests, questions, or unclear points in a text input area displayed on the terminal. The terminal may apply a local language processing algorithm to segment the input text into sentence boundaries or clauses. The terminal then transmits the text to the server over a communication network such as the Internet using a protocol such as HTTP over a secure transport layer. In some embodiments, the terminal converts the text into a bullet-point format locally by splitting the text into discrete items and representing them as a list structure before transmission.

The server receives the input information and applies a language processing algorithm. The server tokenizes the text using a tokenizer that converts characters into tokens based on word boundaries, subword units, or byte-pair encodings. The server identifies delimiters or sentence boundaries and structures the text into multiple bullet-point items. The server stores these items in a structured text data structure such as an array or list where each element corresponds to a particular user intention. By structuring the input in this way, the server reduces ambiguity for subsequent generative AI processing and avoids processing a monolithic string that might blend multiple intentions.

The server then applies the emotion analysis algorithm to the bullet-point items. The server encodes each bullet point into an embedding vector and feeds the embeddings into the emotion analysis model. The server computes a predicted emotion label or score for each bullet point and optionally aggregates the results to produce an overall emotion category for the entire input. The server then uses this emotion information as part of the control parameters for prompt sentence generation.

The server generates a prompt sentence by combining the structured text data and the emotion information into an instruction-like natural language string. The server inserts the bullet-point contents and explicit control phrases describing the desired tone, politeness, and urgency. For example, the server may generate a prompt sentence such as: “User bullet points: ‘product availability status’, ‘request to change the delivery date and time’. Emotion: ‘urgent’. Please generate a polite inquiry letter in Japanese that reflects the user's urgency.”

In another example, the server may generate a prompt sentence such as: “User input: ‘the product delivery is delayed’. Detected emotion: ‘dissatisfied’. Please generate a polite but clearly dissatisfied message in Japanese that apologizes for the inconvenience to the customer and promises to check the delivery status.”

The server passes the prompt sentence to the generative AI model by converting the text into a sequence of tokens using the tokenizer associated with the model. The server prepares an input tensor of token indices and corresponding positional encodings, and forwards these through the transformer layers. The model produces output logits for each position, which the server converts into probabilities using a softmax function. The server selects tokens according to a decoding strategy, such as greedy decoding, top-k sampling, or nucleus sampling (top-p). The server may impose constraints on maximum number of tokens, repetition penalties, and forbidden phrases to ensure generation quality.

The server generates text data in a natural language based on the sampled tokens and reconstructs a string using the inverse tokenizer. The server trims extraneous symbols and ensures that sentence boundaries are coherent. The server then transmits the text data to the terminal. By constructing a prompt sentence explicitly conditioned on structured items and emotion information, the server reduces the search space of the generative AI model and improves the relevance and tonal accuracy of the generated text, thereby reducing the likelihood that multiple re-generation cycles will be necessary.

The terminal receives the generated text data and displays it to the user via a user interface. The terminal presents the text in an editable text area and also displays the corresponding bullet-point items, so that the user can understand how the original intentions map to the generated text. The terminal provides an editing tool that allows the user to select words, sentences, or paragraphs using a pointing device, to delete or insert text using a keyboard, and to reorder segments by drag-and-drop gestures. The terminal must manage internal data structures, such as a text buffer and a selection model, to maintain the correspondence between screen coordinates and textual offsets.

The terminal also enables voice-based editing. The user activates a microphone control and speaks a command or additional sentence. The terminal captures audio data from the microphone, encodes the audio into a suitable format, and transmits it to a speech recognition algorithm. The speech recognition algorithm may be executed locally on the terminal or remotely on a server. The algorithm extracts acoustic features such as Mel-frequency cepstral coefficients, feeds them through an acoustic model such as a deep neural network or a sequence-to-sequence model with attention, and decodes a textual transcription. The terminal receives the transcription and interprets it according to predefined editing rules; for example, if the transcription matches a pattern such as “add ‘thank you in advance’ to the end,” the terminal appends the quoted phrase to the end of the text. The terminal updates the display in real time as these edits are applied.

The server can further process edited text data. After the user modifies the text, the terminal transmits the edited version back to the server. The server runs the emotion analysis algorithm again on the edited text to detect changes in emotion or tone. Based on this updated emotion information and the edited content, the server regenerates a new prompt sentence. For example, the server may generate a refinement prompt such as:

“Current draft: ‘I would like to urgently check the product availability. In addition, I would like to request a change to the delivery date and time. Thank you in advance.’. Emotion: ‘urgent but polite’. Please improve clarity and formal politeness in Japanese without changing the main meaning.”

The server provides this refined prompt sentence to the generative AI model. Because the server uses the edited text as context, the generative AI model is constrained to stay near the user-edited version while improving style and consistency. The model's attention mechanism focuses on the provided draft, which reduces the variance in generated output relative to an unconstrained generation. This processing improves textual quality while minimizing user effort.

The server returns the improved version of the text to the terminal. The terminal displays both the user-edited version and the improved version, or highlights differences between them, and allows the user to select one as the final version. The terminal can compute and display a diff between the two versions using a text comparison algorithm, and the user can quickly verify that no essential meaning has been lost.

Once the user designates a final version, the server transmits the text as inquiry information to an external information processing apparatus via the communication network. The server formats the text into a protocol-specific payload, such as an email message body or a ticket creation request for a customer support system, and sends it using a transport protocol such as SMTP or a RESTful HTTP request. The server may also store metadata, including the original bullet-point items, emotion labels, prompt sentences, and model parameters used, in a log database for later analysis and system improvement. This configuration provides technical improvements over conventional systems. By structuring user input into bullet-point items and using them as explicit control inputs to prompt sentence generation, the server reduces unnecessary processing by the generative AI model and improves the determinism of model output. The transformer-based generative AI model processes more targeted instructions, which reduces the number of tokens needed for context and thus lowers inference latency and computing resource consumption. The emotion analysis model provides additional conditioning that allows the server to adjust tone and urgency at the model input level, instead of requiring multiple user-driven correction cycles, which further reduces overall processing time and network traffic.

The integration of voice-derived editing commands and pointing-device operations into a unified editing tool also improves computational efficiency. The terminal performs local editing operations without invoking the generative AI model, and only when the user initiates a refinement request does the server perform additional model inference. This separation of local operations from server-side generation reduces the volume of data sent over the network and reduces the frequency of server calls, which in turn decreases communication load and server utilization.

The server employs non-conventional processing sequences and rules that differ from manual drafting workflows. Instead of simply generating a draft and letting a user rewrite it, the server applies a cycle of: (i) structural decomposition into bullet points, (ii) emotion-conditioned prompt sentence construction, (iii) model-based generation, (iv) user editing with local operations, and (v) re-analysis and refinement based on edited text. This cycle leverages machine-learned models in combination with structured intermediate representations and specific control prompts, resulting in a more predictable and technically optimized text generation pipeline.

Alternative embodiments can modify specific components while remaining within the scope of the invention. For example, the language processing algorithm may use different tokenization strategies, such as character-based segmentation for languages without explicit word boundaries. The emotion analysis algorithm may use a rule-based lexicon approach instead of a neural classifier, or may use a hybrid approach combining lexicon scores and learned representations. The generative AI model may use alternative architectures, such as a recurrent neural network with attention or a convolutional sequence model, provided that it generates natural language text from prompt sentences.

The server may also implement caching strategies, where prompt sentences and corresponding model outputs are stored in a cache and reused when identical or highly similar structured text data and emotion information are received. This reduces redundant inference computations and improves throughput. The server may also perform load balancing across multiple inference instances of the generative AI model, using a scheduler that allocates requests to different accelerator devices based on current load and inference time estimates.

The terminal may further support offline modes where initial bullet-point structuring and basic emotion estimation are performed locally using smaller models, and refined processing occurs when a network connection is available. The terminal may compress edited text data and metadata using a text compression algorithm before transmission to reduce bandwidth usage. The system may also support different user interface layouts, for example, separate panes for bullet points, generated text, and emotion indicators, to facilitate efficient user interaction.

Through these embodiments, the server and terminal cooperate to implement a specific, technically grounded data flow, data structure, and algorithmic pipeline that transforms user natural language input into structured representations, conditions generative text creation on emotion information and explicit prompt sentences, and iteratively refines and selects final text with reduced computational overhead and improved technical performance, rather than merely automating a human drafting process.

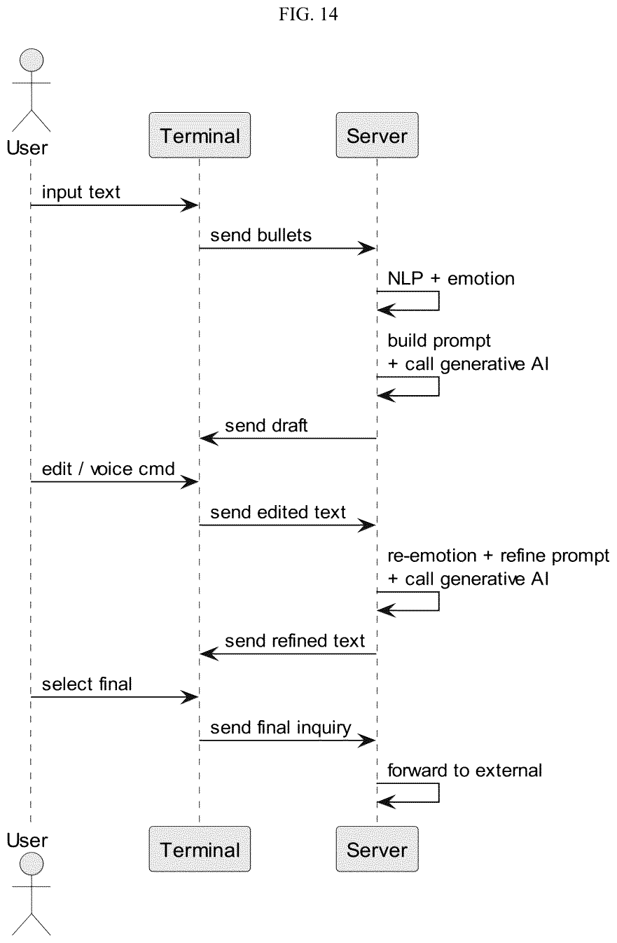

The following describes the processing flow using FIG. 14.

### Step 1

User operates the terminal to input initial natural-language content.

User types or dictates one or more requests, questions, or unclear points into a text input area on the terminal, such as “I would like to know the product availability status” or “The product delivery is delayed”.

Input: raw natural-language text from the user.

Output: UTF-8 encoded text stored in a text buffer on the terminal.

Terminal stores this text string in local memory and associates it with a session identifier, without yet performing structural analysis.

### Step 2

Terminal converts the raw text into a bullet-point structure.

Terminal executes a local language processing algorithm (for example, sentence segmentation and clause detection) to split the input text into shorter units.

Input: the raw text buffer from Step 1.

Output: an ordered list (array) of text items representing bullet points.

Terminal removes extra whitespace, identifies sentence boundaries based on punctuation and language rules, and constructs a data structure such as [item_1, item_2, . . . ], where each item corresponds to a distinct request or question. Terminal then renders these items as bullet points in the user interface so that the user can visually confirm them.

### Step 3

User optionally edits the bullet-point items on the terminal.

User taps or clicks on individual bullet points and modifies text via a software keyboard, or deletes or adds items as needed.

Input: the bullet-point list displayed on the terminal.

Output: a revised bullet-point list reflecting the user's corrections.

Terminal updates the list in memory after each edit event, recalculating character offsets and updating the on-screen representation so that the displayed bullets always correspond exactly to the internal list.

### Step 4

Terminal transmits the structured bullet-point data to the server.

Terminal encodes the bullet-point list and metadata (for example, language code, session ID) into a JSON or similar structured message and sends it via HTTP or HTTPS to the server.

Input: the revised bullet-point list from Step 3.

Output: a network request containing structured text data delivered to the server.

Terminal opens a TCP/IP connection, sets appropriate headers (such as Content-Type: application/json), serializes the list into a string, and writes it to the network socket for delivery.

### Step 5

Server receives and normalizes the bullet-point data.

Server listens on an API endpoint, parses the incoming request, and extracts the structured text items.

Input: serialized structured text (JSON payload) from the terminal.

Output: an internal structured representation (for example, an array of strings) stored in server memory.

Server applies normalization operations such as Unicode normalization, removal of control characters, and optional language detection to ensure that subsequent processing is consistent. Server also assigns an internal request ID and stores the normalized items in a processing queue.

### Step 6

Server performs tokenization and further linguistic preprocessing.

Server executes a language processing algorithm (for example, a tokenizer based on word or subword units) on each bullet-point string.

Input: the normalized array of bullet-point strings from Step 5.

Output: for each bullet point, a token sequence (for example, a list of token IDs or token strings) and a cleaned text string.

Server splits text into tokens, removes or standardizes punctuation where appropriate, and may compute additional features such as part-of-speech tags or n-gram statistics. These features are stored in an internal data structure that maps each bullet point to its tokenized representation.

### Step 7

Server performs emotion analysis on the bullet-point data.

Server passes the cleaned bullet-point strings or their embeddings to an emotion analysis model (for example, a neural classifier).

Input: the cleaned text strings or token sequences from Step 6.

Output: emotion information, such as labels (e.g., “urgent”, “dissatisfied”, “neutral”) or numeric scores, associated with each bullet point and optionally aggregated for the entire request.

Server converts tokens to embeddings, runs them through the emotion analysis network, and computes a probability distribution over emotion classes. Server then selects the most probable class or computes a weighted score and stores this emotion information in memory.

### Step 8

Server constructs a prompt sentence for the generative AI model.

Server combines the structured bullet points and emotion information into an instruction-like natural-language prompt.

Input: the structured bullet-point list and associated emotion information from Step 7.

Output: a single prompt sentence (string) prepared for the generative AI model.

Server concatenates bullet points with delimiters and inserts explicit control phrases specifying tone and behavior. For example, the server may generate:

“User bullet points: ‘product availability status’, ‘request to change the delivery date and time’. Emotion: ‘urgent’. Please generate a polite inquiry letter in Japanese that reflects the user's urgency.”

Server stores this prompt sentence as the generative model's input context.

### Step 9

Server encodes the prompt sentence and invokes the generative AI model.

Server uses a tokenizer associated with the generative AI model to convert the prompt sentence into token IDs, constructs an input tensor, and feeds it through the model.

Input: the prompt sentence string from Step 8.

Output: generated token sequences representing the draft text.

Server performs forward propagation through the transformer layers, obtains logits over the vocabulary at each position, applies softmax to convert logits to probabilities, and samples or selects tokens according to a decoding strategy (e.g., greedy or top-p sampling). The resulting sequence of token IDs is stored as the model's output.

### Step 10

Server decodes the generated token sequence into natural-language text.

Server converts the sequence of token IDs back into characters using the inverse tokenizer and post-processes the output.

Input: generated token sequence from Step 9.

Output: a generated draft text string in natural language.

Server merges subword tokens, fixes spacing and punctuation, removes incomplete trailing phrases if necessary, and ensures that the text ends at a sentence boundary. The resulting draft text is associated with the request ID and prepared for transmission.

### Step 11

Server transmits the generated draft text to the terminal.

Server packs the generated text and optionally the bullet points and emotion metadata into a response payload and sends it back over the network.

Input: the draft text string and related metadata from Step 10.

Output: an HTTP/HTTPS response carrying the generated text to the terminal.

Server serializes the data into JSON or another structured format and writes it to the response body, which is then delivered to the terminal over the existing TCP/IP connection.

### Step 12

Terminal displays the generated text and enables manual editing.

Terminal parses the server response and renders the generated draft text in an editable text control.

Input: the generated draft text and associated metadata from Step 11.

Output: a visible text area showing the draft and an internal editable text buffer.

Terminal initializes a text buffer with the received text, sets cursor and selection states, and binds editing events (keyboard input, pointer events) to update the buffer. The user can tap, click, or type to modify any part of the text.

### Step 13

User performs text edits using a pointing device or keyboard.

User selects segments of text, deletes words, inserts new phrases, or reorders sentences via drag-and-drop or cursor movements.

Input: the displayed draft text and user interaction events.

Output: an updated version of the draft text stored in the terminal's text buffer.

Terminal processes each input event, updates the internal character array or rope data structure that represents the text, recalculates layout and display positions, and immediately re-renders the edited text so that the screen content stays synchronized with the buffer.

### Step 14

User invokes voice-based editing commands.

User presses a microphone icon and speaks commands such as “Add ‘thank you in advance’at the end” or additional sentences to be inserted.

Input: audio signals captured by the microphone.

Output: recognized text commands and/or additional content.

Terminal records audio samples, encodes them (for example, into a compressed audio format), and sends them to a speech recognition system. The system converts the audio into text, which the terminal receives and interprets. If the recognized text matches predefined command patterns, the terminal performs corresponding edit operations (e.g., append a phrase at the end). The terminal then updates the text buffer and redisplays the modified text.

### Step 15

Terminal sends the edited text back to the server for refinement (optional).

User may select an option such as “Refine with AI” to request an improved version of the edited text.

Input: the current edited text buffer on the terminal.

Output: a network request containing the edited text and optional tone instructions sent to the server.

Terminal packages the entire edited text string and any user-selected tone options (e.g., “more polite”, “softer tone”) into a structured message and sends it to the server via HTTP/HTTPS, again over the communication network.

### Step 16

Server performs a second emotion analysis on the edited text.

Server applies the emotion analysis algorithm to the full edited text to detect the updated emotional state.

Input: the edited text string from Step 15.

Output: updated emotion information, such as refined emotion labels or scores.

Server encodes the edited text into embeddings and re-runs the classifier, computing a new distribution over emotion categories. The server then stores the updated emotion label associated with this revised content.

### Step 17

Server constructs a refinement prompt sentence using edited text and updated emotion.

Server builds a new prompt sentence that instructs the generative AI model to improve clarity, style, or tone without altering the main meaning.

Input: the edited text and updated emotion information from Step 16.

Output: a refinement prompt sentence string.

Server creates an instruction such as: “Current draft: ‘I would like to urgently check the product availability. In addition, I would like to request a change to the delivery date and time. Thank you in advance.’. Emotion: ‘urgent but polite’. Please improve clarity and formal politeness in Japanese without changing the main meaning.”

Server stores this string as the new model input.

### Step 18

Server encodes the refinement prompt and re-invokes the generative AI model.

Server tokenizes the refinement prompt, constructs input tensors, and runs inference again through the generative AI model.

Input: the refinement prompt sentence from Step 17.

Output: a new generated token sequence representing an improved version of the text.

Server performs forward passes through the transformer layers, obtains logits, and decodes a sequence using a selected sampling or selection strategy. Because the prompt contains the full draft text, the model's attention layers use the existing text as context, leading to output that stays close to the original meaning while improving phrasing.

### Step 19

Server decodes the improved token sequence into refined text.

Server converts the generated token sequence to characters and post-processes the result for readability.

Input: the improved token sequence from Step 18.

Output: a refined natural-language text string.

Server merges tokens, adjusts punctuation and spacing, and ensures that the result forms coherent sentences. The refined text is then linked to the session and prepared for transmission.

### Step 20

Server sends the refined text to the terminal for comparison.

Server generates a response message that includes both the refined text and optionally the edited text for side-by-side display.

Input: the refined text string and the original edited text (for reference) from Step 19 and Step 15.

Output: a network response transmitted to the terminal.

Server serializes this information into a structured response and sends it via the communication network to the terminal.

### Step 21

Terminal displays the refined text and allows final selection.

Terminal presents the refined text alongside or in replacement of the edited text, and optionally highlights differences between versions.

Input: the refined text and edited text from Step 20.

Output: a user interface view showing selectable candidate final texts.

Terminal may run a diff algorithm on the two texts, mark insertions and deletions with colors or underlines, and provide controls such as radio buttons or selection icons for the user to choose which version should be the final version.

### Step 22

User selects a final version of the text.

User reviews the displayed versions and chooses one as the definitive version for transmission, using a “Select” or “Confirm” control.

Input: the candidate texts displayed on the terminal and the user's selection command.

Output: a designation of one text string as the final version stored in terminal memory.

Terminal records the identifier of the chosen version, locks the corresponding text buffer to prevent accidental further edits, and prepares the final text for sending.

### Step 23

Terminal sends the final version of the text to the server as inquiry information.

Terminal transmits the selected final text to the server over the communication network.

Input: the final text selected in Step 22.

Output: a network request including the final text, destined for the server.

Terminal encodes the final text into a structured message, attaches metadata such as user ID and timestamp, and sends it via HTTP/HTTPS to the server.

### Step 24

Server processes and forwards the final inquiry to an external system.

Server receives the final text and prepares it for use by an external information processing apparatus, such as a customer support system.

Input: the final inquiry text from Step 23.

Output: a formatted communication (e.g., API request, email content, or ticket data) sent to an external system and a stored record in a database.

Server converts the text into the format required by the external system (for example, a JSON payload for an API or an email body), transmits it over a network protocol such as HTTP or SMTP, and stores the final text and related metadata in a persistent storage system for logging, search, and audit.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

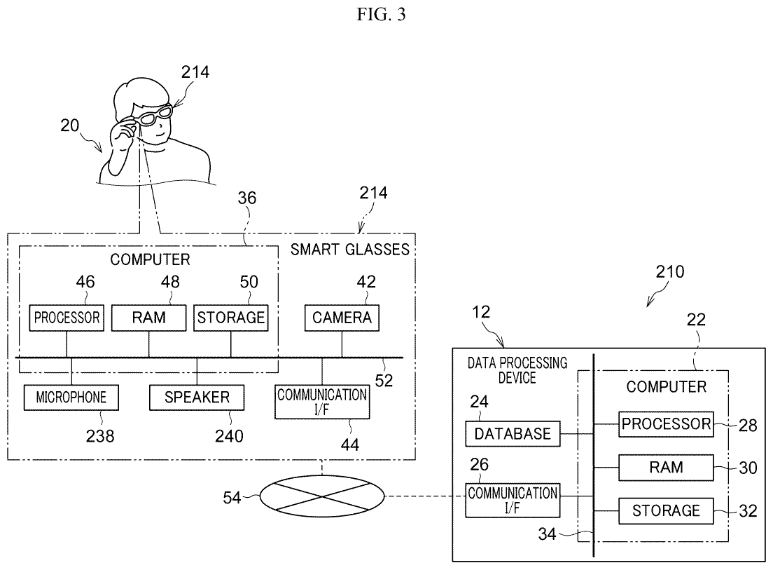

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

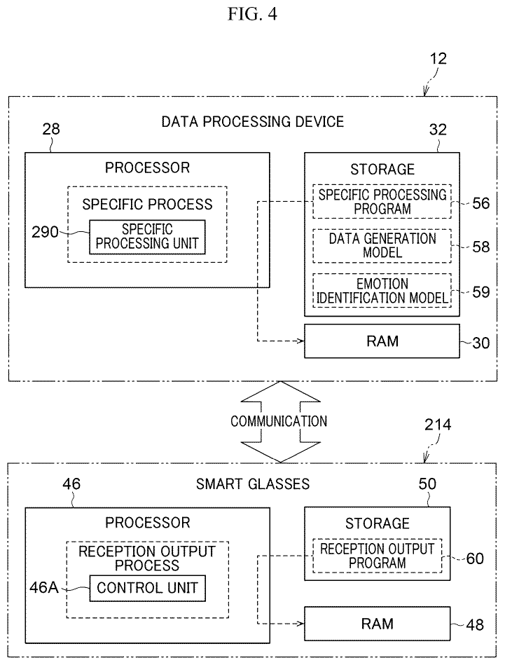

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

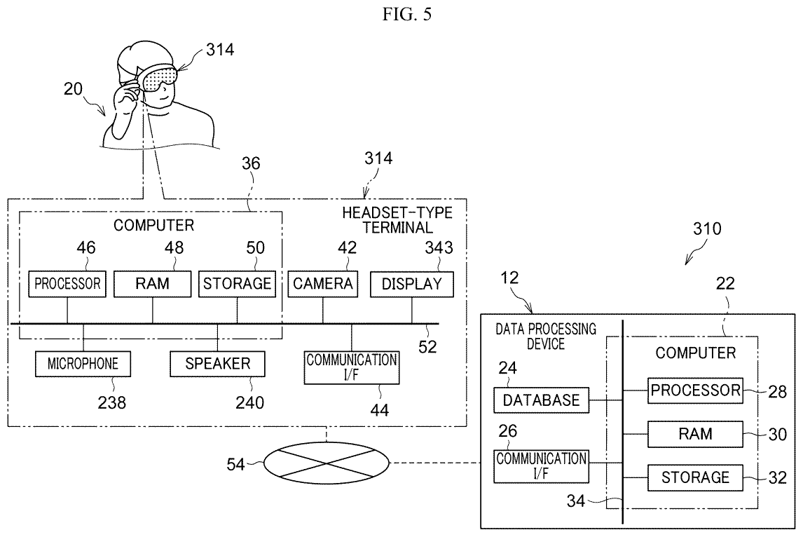

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

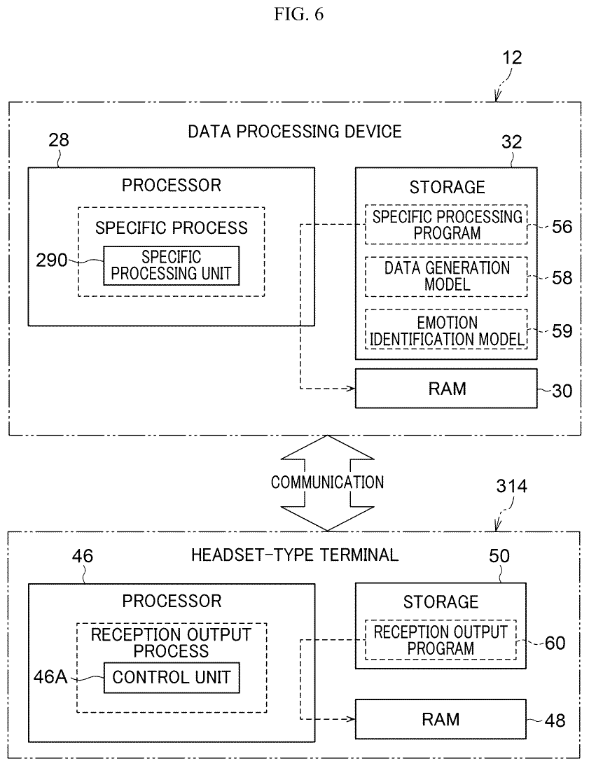

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

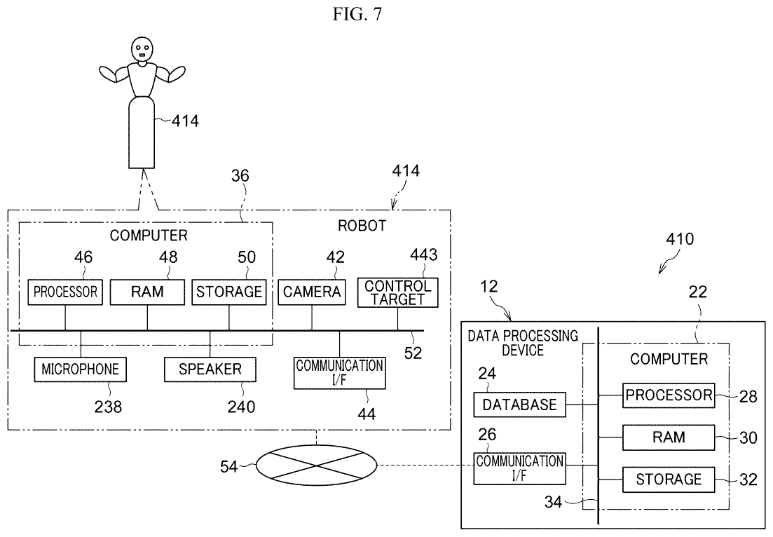

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

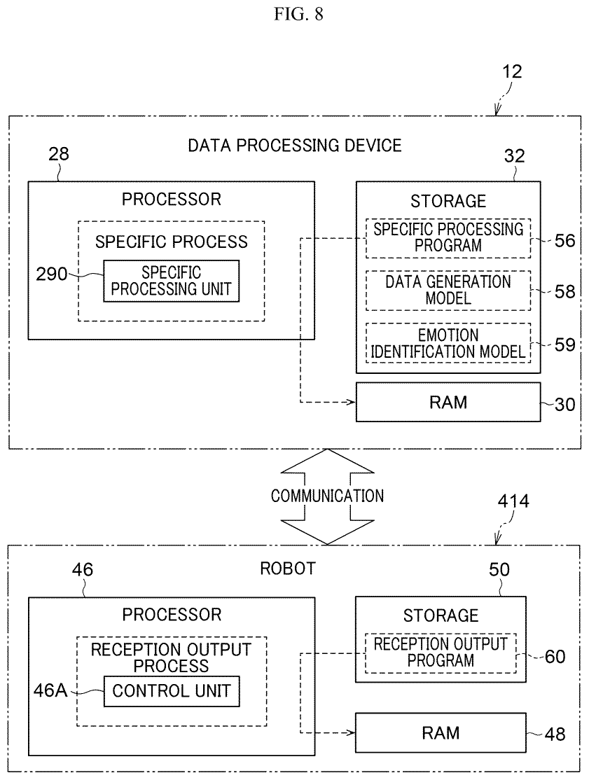

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

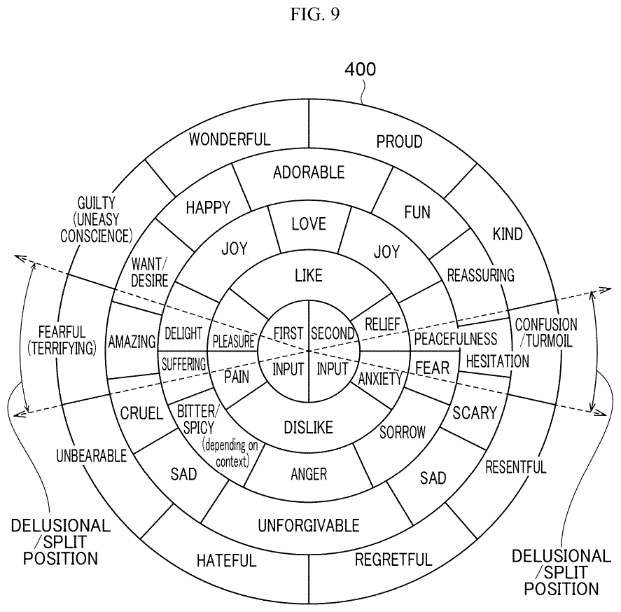

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

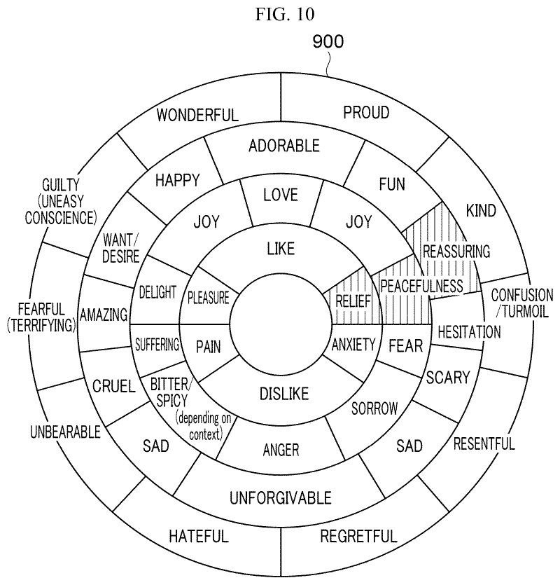

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire structured data including a plurality of requirement items from a user terminal, and perform format validation and content validation on the structured data,
convert the plurality of requirement items into a single prompt sentence suitable as input to a generative AI model by adding a fixed instruction sentence, style conditions, and output format conditions, and generate model input data including the prompt sentence,
transmit the model input data to an internal or external generative AI model and request execution of natural language text generation processing by the generative AI model,
receive, as a response from the generative AI model, a generated natural language text, and perform post-processing including normalization of line breaks, character encoding, and sentence-ending expressions on the generated natural language text,
generate response data including the post-processed natural language text, the plurality of requirement items, and the prompt sentence, and transmit the response data via a communication network to a terminal executing a user interface,
present the natural language text, via the user interface of the terminal, as an editable input area, and accept editing information that enables a user to add or modify the natural language text, and
convert a natural language text finalized based on the editing information into transmission data that is transmittable as inquiry information to another information processing apparatus.

### Supplementary 2

The system according to supplementary 1,
wherein the processor is configured to
control, in generating and transmitting the transmission data, the inclusion of the post-processed natural language text as the inquiry information without modification when the natural language text has not been edited by the user.

### Supplementary 3

The system according to supplementary 1,
wherein the processor is configured to
embed the plurality of requirement items in the prompt sentence in a list format, and add a description including conditions relating to a use language, a speaker viewpoint, a politeness level, and a document length, thereby controlling a style and content of the natural language text generated by the generative AI model.

Application Example 1

### Supplementary 1

A system comprising a processor,
wherein the processor is configured to
receive, from a terminal operated by a user, a plurality of request information items input by the user in a bullet-point format and acquire the plurality of request information items as structured data,
create, on the basis of the plurality of request information items acquired as the structured data in the bullet-point format, a prompt sentence including a generation instruction for a generative AI model, and transmit the prompt sentence as input data to a generative AI model through a generative AI model interface,
obtain, from the generative AI model, response data including a natural-language sentence generated on the basis of the prompt sentence, and perform string-formatting processing and quality-checking processing on the natural-language sentence,
transmit the natural-language sentence that has passed the quality-checking processing to the terminal, cause the terminal to display the natural-language sentence in an editable display region, and acquire a corrected natural-language sentence through an editing operation performed by the user, and
register the corrected natural-language sentence as inquiry information of the user in a recording data storage unit and output the corrected natural-language sentence as inquiry data to be transmitted to an inquiry-processing system or an information-retrieval system.

### Supplementary 2

The system according to supplementary 1,
wherein the processor is configured to, in a case where no editing operation is performed by the user on the natural-language sentence at the terminal, automatically transmit the natural-language sentence that has passed the quality-checking processing, as inquiry information of the user, to the inquiry-processing system or the information-retrieval system by automatic transmission control.

### Supplementary 3

The system according to supplementary 1,
wherein the processor is configured to, on the basis of the corrected natural-language sentence output as the inquiry data, use a classification model or a generative AI model to automatically determine an inquiry category and determine, in accordance with the automatically determined inquiry category, a processing destination or a processing priority within the inquiry-processing system.

Example 2

### Supplementary 1

A system comprising a processor,
wherein the processor is configured to
acquire request information input by a user via a terminal, and convert the request information into structured information including a plurality of items by using a natural language processing algorithm, and
construct, on the basis of the structured information and the request information, a prompt sentence for instructing a generative AI model to generate a natural language text, and input the prompt sentence to the generative AI model so as to cause the generative AI model to generate the natural language text, and
transmit the natural language text generated by the generative AI model to the terminal via a communication network, and cause the terminal to display the natural language text so as to present the natural language text to the user on a user interface, and
cause the terminal to accept an editing operation for the natural language text, the editing operation including addition, deletion, or modification of a character string of the natural language text, update the natural language text in accordance with the editing operation, and acquire an updated version of the natural language text as a finalized text, and store the finalized text and the request information in an information storage device in association with identification information and time information, and enable the finalized text to be subsequently searched for and acquired on the basis of the identification information.

### Supplementary 2

The system according to supplementary 1,
wherein the processor is configured to
acquire a history of the editing operation on the natural language text generated by the generative AI model, and accumulate the history of the editing operation as learning information used to sequentially update a configuration of the prompt sentence to be input to the generative AI model or a generation condition of the generative AI model.

### Supplementary 3

The system according to supplementary 1,
wherein the processor is configured to
control transmission such that the finalized text is transmitted, as inquiry information, to an external information processing apparatus via the communication network, and such that the transmission is automatically executed on condition that a confirmation operation by the user with respect to the finalized text has been accepted.

Application Example 2

### Supplementary 1

A system comprising a processor,
wherein the processor is configured to
receive input information in a natural language from a user and convert the input information into structured text data in a bullet-point format including a plurality of items by using a language processing algorithm,
generate a prompt sentence including sentence generation conditions reflecting emotion information of the user, based on the structured text data in the bullet-point format and the emotion information estimated by an emotion analysis algorithm, and cause a generative AI model to generate text data in a natural language by inputting the prompt sentence to the generative AI model,
display the text data generated by the generative AI model via a user interface and provide an editing tool that enables the user to confirm the text data and modify the text data based on an operation of a pointing device or based on an editing operation derived from voice input acquired by a speech recognition algorithm, and update and display the text data in real time according to a result of the editing operation, analyze edited text data again by using the emotion analysis algorithm, regenerate the prompt sentence based on an analysis result, input the regenerated prompt sentence to the generative AI model, and thereby automatically generate an improved version of the text data, and
cause the user interface to display at least one of the text data automatically generated by the generative AI model and the text data edited by the user so that the at least one of the text data is selectable as a final version.

### Supplementary 2

The system according to supplementary 1,
wherein the processor is configured to
transmit, as inquiry information, text data selected by the user as the final version from among the edited text data and the text data automatically generated by the generative AI model, to an external information processing apparatus via a communication network.

### Supplementary 3

The system according to supplementary 1,
wherein the processor is configured to
automatically transmit, as inquiry information via the communication network, the text data selected as the final version after the user performs a final confirmation operation via the user interface without requiring an additional operation by the user.

What is claimed is:

1. A system comprising:
circuitry configured to:
receive, from a terminal device via a communication interface coupled to a packet-switched network, input data representing a plurality of items, and convert the input data into structured data in a list format by executing a natural language processing algorithm;
generate, based on the structured data, a prompt sentence for instructing a generative neural network model to generate a natural language text, the prompt sentence including at least the structured data and an instruction portion specifying generation conditions;
transmit the prompt sentence to the generative neural network model, acquire a generated natural language text from the generative neural network model, and perform post-processing on the generated natural language text; and
transmit response data including the post-processed natural language text to the terminal device via the communication interface and the packet-switched network, the response data causing the terminal device to present the post-processed natural language text in an editable region of a user interface.

2. The system according to claim 1, wherein the circuitry is further configured to perform format validation and content validation on the structured data before generating the prompt sentence, the format validation including verifying that a number of items in the structured data is within a predetermined range and that each item does not exceed a predefined character limit, and the content validation including scanning the items for prohibited character sequences using pattern matching.

3. The system according to claim 2, wherein the circuitry is further configured to discard or flag items that violate the format validation or the content validation, and to generate an internally validated representation of the structured data for use in generating the prompt sentence.

4. The system according to claim 1, wherein the prompt sentence further includes a fixed instruction sentence retrieved from a template stored in a storage device, style conditions specifying at least one of a language, a speaker viewpoint, a politeness level, and a document length, and output format conditions specifying a structure of the generated natural language text.

5. The system according to claim 4, wherein the circuitry is further configured to set generation parameters for the generative neural network model, the generation parameters including at least one of a temperature value, a maximum token number, and a sampling strategy, and to generate model input data by combining the prompt sentence with the generation parameters.

6. The system according to claim 5, wherein the generative neural network model comprises a transformer-based neural network including an embedding layer, a plurality of self-attention layers, and an output projection layer, and wherein the generative neural network model is trained using a cross-entropy loss function and a gradient descent optimization algorithm.

7. The system according to claim 6, wherein training of the generative neural network model includes data augmentation techniques comprising at least one of token masking and random span corruption.

8. The system according to claim 1, wherein the post-processing includes at least one of normalization of line breaks, normalization of character encoding, enforcement of a consistent sentence-ending punctuation pattern, and truncation of the generated natural language text when the generated natural language text exceeds a predetermined size.

9. The system according to claim 8, wherein the response data further includes the plurality of items of the structured data and the prompt sentence, and the circuitry is further configured to include metadata comprising at least one of a model identifier, a generation timestamp, and token usage statistics in the response data.

10. The system according to claim 1, wherein the circuitry is further configured to receive, from the terminal device via the communication interface, editing information indicating modifications made by an operator to the post-processed natural language text in the editable region, and to determine, based on the editing information, whether the post-processed natural language text was modified.

11. The system according to claim 10, wherein the circuitry is further configured to, when the post-processed natural language text was not modified, automatically treat the post-processed natural language text as finalized data, and to, when the post-processed natural language text was modified, use an edited version as the finalized data.

12. The system according to claim 11, wherein the circuitry is further configured to convert the finalized data into transmission data and transmit the transmission data to another information processing apparatus via the communication interface and the packet-switched network.

13. The system according to claim 12, wherein the circuitry is further configured to perform, on the finalized data, a classification operation using at least one of a classification model and the generative neural network model to determine a category label, and to determine a processing destination or a processing priority for the transmission data based on the category label.

14. The system according to claim 10, wherein the circuitry is further configured to acquire a history of editing operations performed on the post-processed natural language text and accumulate the history as learning information used to update at least one of a configuration of the prompt sentence and a generation condition of the generative neural network model.

15. The system according to claim 1, wherein the circuitry is further configured to estimate an emotion of an operator by applying an emotion identification model to sensor data received from the terminal device via the communication interface, and to adjust at least one of the prompt sentence and the generation conditions based on the estimated emotion.

16. The system according to claim 15, wherein the emotion identification model comprises a neural network trained on training data sets that each combine a user input with an emotion value mapped on an emotion map, and wherein the emotion identification model classifies the emotion into at least one of a plurality of emotion categories.

17. The system according to claim 15, wherein the sensor data includes at least one of audio data representing speech of the operator, image data representing a facial expression of the operator, and text data representing textual input of the operator, and wherein the emotion identification model performs multi-modal emotion analysis on the sensor data.

18. A system comprising:
circuitry configured to:
receive, from a terminal device via a communication interface coupled to a packet-switched network, input data representing a plurality of requirement items input by an operator, and convert the input data into structured data in a bullet-point format by executing a natural language processing algorithm including at least one of tokenization, parsing, and entity extraction;
perform format validation including verifying that a number of the requirement items is within a predetermined range and content validation including scanning for prohibited character sequences, and generate a validated representation of the structured data;
generate, based on the validated representation, a prompt sentence for instructing a generative neural network model to generate a natural language inquiry sentence, the prompt sentence including a fixed instruction sentence, style conditions specifying at least one of a language, a speaker viewpoint, and a politeness level, output format conditions, and the requirement items embedded in a list format;
set generation parameters including at least one of a temperature value, a maximum token number, and a sampling strategy, transmit model input data including the prompt sentence and the generation parameters to the generative neural network model, acquire a generated natural language inquiry sentence, and perform post-processing including normalization of line breaks, character encoding, and sentence-ending expressions;
transmit response data including the post-processed natural language inquiry sentence, the requirement items, and the prompt sentence to the terminal device via the communication interface and the packet-switched network, the response data causing the terminal device to present the post-processed natural language inquiry sentence in an editable input area;
receive editing information from the terminal device indicating whether the operator modified the post-processed natural language inquiry sentence, determine a finalized natural language text based on the editing information, and convert the finalized natural language text into transmission data; and
transmit the transmission data as inquiry information to another information processing apparatus via the communication interface and the packet-switched network.

19. The system according to claim 18, wherein the generative neural network model comprises a transformer-based neural network including an embedding layer that maps discrete tokens to vector representations, a sequence of self-attention and feed-forward layers, and an output projection layer that converts hidden state vectors into probability distributions over a token vocabulary, and wherein the generative neural network model is trained by minimizing a cross-entropy loss between predicted tokens and reference tokens using gradient descent, with data augmentation comprising at least one of token masking and random span corruption.

20. A method performed by a system comprising circuitry, the method comprising:
receiving, from a terminal device via a communication interface coupled to a packet-switched network, input data representing a plurality of items, and converting the input data into structured data in a list format by executing a natural language processing algorithm;
generating, based on the structured data, a prompt sentence for instructing a generative neural network model to generate a natural language text, the prompt sentence including at least the structured data and an instruction portion specifying generation conditions;
transmitting the prompt sentence to the generative neural network model, acquiring a generated natural language text from the generative neural network model, and performing post-processing on the generated natural language text; and
transmitting response data including the post-processed natural language text to the terminal device via the communication interface and the packet-switched network, the response data causing the terminal device to present the post-processed natural language text in an editable region of a user interface.
